(19) United States
(12) Patent Application Publication
(10) Pub. No.: US 2026/0220917 A1
(43) Pub. Date: Jul. 30, 2026

(54) IMAGE CLASSIFICATION METHOD AND APPARATUS, AND ELECTRONIC DEVICE, COMPUTER-READABLE STORAGE MEDIUM AND COMPUTER PROGRAM PRODUCT

(71) Applicant: Tencent Technology (Shenzhen) Company Limited, Shenzhen (CN)

(72) Inventors: Yu ZHAO, Shenzhen (CN); Bing HE, Shenzhen (CN); Chenchen QIN, Shenzhen (CN); Jianhua YAO, Shenzhen (CN)

(73) Assignee: Tencent Technology (Shenzhen) Company Limited, Shenzhen (CN)

(21) Appl. No.: 19/575,276

(22) Filed: Mar. 23, 2026

Related U.S. Application Data
(63) Continuation of application No. PCT/CN2024/120338, filed on Sep. 23, 2024.

(30) Foreign Application Priority Data
Dec. 5, 2023 (CN) 202311661392.1

(51) Int. Cl. G06V 10/764; G06N 3/048

(52) U.S. Cl. CPC G06V 10/764; G06N 3/048

(57) ABSTRACT

This application provides an image classification method and apparatus, an electronic device, a computer-readable storage medium, and a computer program product. The method includes: obtaining a to-be-classified image including a plurality of to-be-classified sub-images, and converting the to-be-classified image between different modalities, to obtain modality information of the to-be-classified image that corresponds to each modality; performing modality fusion on all pieces of modality information, to obtain a multimodal vector corresponding to the to-be-classified image; encoding the to-be-classified image based on the multimodal vector, to obtain a to-be-classified sub-vector in a one-to-one correspondence with each to-be-classified sub-image; and classifying the to-be-classified image based on the to-be-classified sub-vector corresponding to each to-be-classified sub-image, to obtain the category of the to-be-classified image.

### RELATED APPLICATION

This application is a continuation of International Patent Application No. PCT/CN2024/120338, filed on Sep. 23, 2024, which claims priority to Chinese Patent Application No. 2023116613921, filed on Dec. 5, 2023. Both applications are incorporated herein by reference in their entireties.

### FIELD OF THE TECHNOLOGY

This application relates to the field of computer technologies, and in particular, to an image classification method and apparatus, an electronic device, a computer-readable storage medium, and a computer program product.

### BACKGROUND OF THE DISCLOSURE

Artificial intelligence (AI) is a comprehensive discipline, and relates to a wide range of fields including both hardware technologies and software technologies. Basic artificial intelligence technologies generally include technologies related to sensors, dedicated artificial intelligence chips, cloud computing, distributed storage, big data processing, pre-trained models, operating/interaction systems, electromechanical integration, and the like. A pre-trained model is also referred to as a big model or a basic model, and may be widely used in downstream tasks in various directions of artificial intelligence after fine-tuning. AI software technologies mainly include several major directions such as a computer vision technology, a speech processing technology, a natural language processing technology, and machine learning/deep learning.

In related-art information classification, a to-be-classified image is usually classified directly based on a to-be-classified vector of the to-be-classified image, to obtain a category of the to-be-classified image. Because a plurality of to-be-classified sub-images included in the to-be-classified image affects the category of the to-be-classified image, and a single-modality to-be-classified image corresponds to a relatively low information amount, information classification accuracy is relatively low.

### SUMMARY

Embodiments of this application provide an image classification method and apparatus, an image classification model training method and apparatus, an electronic device, a computer-readable storage medium, and a computer program product, to effectively improve information classification accuracy.

Technical solutions of the embodiments of this application are implemented as follows:

The embodiments of this application provide an image classification method, including:
obtaining a to-be-classified image including a plurality of to-be-classified sub-images, and converting the to-be-classified image between different modalities, to obtain modality information of the to-be-classified image that corresponds to each modality;
performing modality fusion on all pieces of modality information, to obtain a multimodal vector corresponding to the to-be-classified image;
encoding the to-be-classified image based on the multimodal vector, to obtain a to-be-classified sub-vector in a one-to-one correspondence with each to-be-classified sub-image; and
classifying the to-be-classified image based on the to-be-classified sub-vector corresponding to each to-be-classified sub-image, to obtain the category of the to-be-classified image.

The embodiments of this application provide an image classification apparatus, including:
an obtaining module, configured to obtain a to-be-classified image including a plurality of to-be-classified sub-images, and convert the to-be-classified image between different modalities, to obtain modality information of the to-be-classified image that corresponds to each modality;
a modality fusion module, configured to perform modality fusion on all pieces of modality information, to obtain a multimodal vector corresponding to the to-be-classified image;
an encoding module, configured to encode the to-be-classified image based on the multimodal vector, to obtain a to-be-classified sub-vector in a one-to-one correspondence with each to-be-classified sub-image; and
a category prediction module, configured to classify the to-be-classified image based on the to-be-classified sub-vector corresponding to each to-be-classified sub-image, to obtain the category of the to-be-classified image.

The embodiments of this application provide an image classification model training method, including:
obtaining a to-be-classified image sample including a plurality of to-be-classified sub-samples, and a sample label carried in the to-be-classified image sample;
encoding the to-be-classified image sample, to obtain a sample vector corresponding to the to-be-classified image sample, the sample vector including a sub-sample vector in a one-to-one correspondence with each to-be-classified sub-sample;
determining, for each to-be-classified sub-sample, the sample label as an initial label of the to-be-classified sub-sample, and invoking the classification model to perform category prediction on the to-be-classified sub-sample based on the sub-sample vector corresponding to the to-be-classified sub-sample, to obtain a prediction probability of the to-be-classified sub-sample;
determining a target label of each to-be-classified sub-sample based on the prediction probability of the to-be-classified sub-sample; and
training the classification model with reference to the prediction probability, the initial label, and the target label, to obtain a target classification model;
the target classification model being configured to perform category prediction on each to-be-classified sub-image in a to-be-classified image, to obtain a prediction probability of each to-be-classified sub-image.

The embodiments of this application provide an image classification model training apparatus, including:
a sample obtaining module, configured to obtain a to-be-classified image sample including a plurality of to-be-classified sub-samples, and a sample label carried in the to-be-classified image sample;
a sample encoding module, configured to encode the to-be-classified image sample, to obtain a sample vector corresponding to the to-be-classified image sample, the sample vector including a sub-sample vector in a one-to-one correspondence with each to-be-classified sub-sample;
a sample prediction module, configured to determine, for each to-be-classified sub-sample, the sample label as an initial label of the to-be-classified sub-sample, and invoke the classification model to perform category prediction on the to-be-classified sub-sample based on the sub-sample vector corresponding to the to-be-classified sub-sample, to obtain a prediction probability of the to-be-classified sub-sample;
a label determining module, configured to determine a target label of each to-be-classified sub-sample based on the prediction probability of the to-be-classified sub-sample; and
a target training module, configured to train the classification model with reference to the predicted probability, the initial label, and the target label, to obtain a target classification model; the target classification model being configured to perform category prediction on each to-be-classified sub-image in a to-be-classified image, to obtain a predicted probability of each to-be-classified sub-image.

The embodiments of this application provide an electronic device, including:
a memory, configured to store computer-executable instructions or computer programs; and
a processor, configured to implement, when executing the computer-executable instructions or the computer programs stored in the memory, the image classification method provided in the embodiments of this application.

The embodiments of this application provide an electronic device, including:
a memory, configured to store computer-executable instructions or computer programs; and
a processor, configured to implement, when executing the computer-executable instructions or the computer programs stored in the memory, the image classification model training method provided in the embodiments of this application.

The embodiments of this application provide a computer-readable storage medium, which has computer programs or computer-executable instructions stored therein, executed by a processor to implement the image classification method provided in the embodiments of this application.

The embodiments of this application provide a computer-readable storage medium, which has computer programs or computer-executable instructions stored therein, executed by a processor to implement the image classification model training method provided in the embodiments of this application.

The embodiments of this application provide a computer program product, including computer programs or computer-executable instructions, the computer programs or the computer-executable instructions being stored in a computer-readable storage medium. A processor of an electronic device reads the computer-executable instructions from the computer-readable storage medium, and executes the computer programs or the computer-executable instructions, to cause the electronic device to perform the image classification method provided in the embodiments of this application.

The embodiments of this application provide a computer program product, including computer programs or computer-executable instructions, the computer programs or the computer-executable instructions being stored in a computer-readable storage medium. A processor of an electronic device reads the computer-executable instructions from the computer-readable storage medium, and executes the computer-executable instructions, to cause the electronic device to perform the image classification model training method provided in the embodiments of this application.

The embodiments of this application have the following beneficial effects:

The to-be-classified image including a plurality of to-be-classified sub-images is converted between different modalities, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image; category prediction is performed on each to-be-classified sub-image based on the to-be-classified sub-vector corresponding to each to-be-classified sub-image, to obtain a category prediction probability of the to-be-classified sub-image; and the to-be-classified image is classified based on the category prediction probability corresponding to each to-be-classified sub-image, to obtain the category of the to-be-classified image. In this way, modality fusion is performed on modality information obtained by converting the to-be-classified image between different modalities, so that the obtained multimodal vector can accurately reflect modality features of the to-be-classified image from different modalities. In addition, the to-be-classified image is encoded based on the multimodal vector, to obtain the to-be-classified vector, thereby effectively increasing an information amount of the to-be-classified vector. Besides, category prediction is performed on each to-be-classified sub-image based on the to-be-classified vector corresponding to the to-be-classified sub-image. Because the to-be-classified vector on which category prediction is based has a more comprehensive information amount, a category prediction probability obtained through prediction is more accurate. The to-be-classified image is classified based on the accurate category prediction probability, thereby effectively improving information classification accuracy.

### BRIEF DESCRIPTION OF THE DRAWINGS

FIG. 1 is a schematic architectural diagram of an information classification system according to an embodiment of this application;

FIG. 2 is a schematic structural diagram of an electronic device for information classification according to an embodiment of this application;

FIG. 3 is a schematic structural diagram of an electronic device configured to train an image classification model according to an embodiment of this application;

FIG. 4 is a first schematic flowchart of an image classification method according to an embodiment of this application;

FIG. 5 is a second schematic flowchart of an image classification method according to an embodiment of this application;

FIG. 6 is a schematic diagram of a principle for modality fusion according to an embodiment of this application;

FIG. 7 is a third schematic flowchart of an image classification method according to an embodiment of this application;

FIG. 8 is a fourth schematic flowchart of an image classification method according to an embodiment of this application;

FIG. 9 is a first schematic flowchart of an image classification model training method according to an embodiment of this application;

FIG. 10 is a schematic structural diagram of a classification model according to an embodiment of this application;

FIG. 11 is a second schematic flowchart of an image classification model training method according to an embodiment of this application;

FIG. 12 is a third schematic flowchart of an image classification model training method according to an embodiment of this application;

FIG. 13 is a fourth schematic flowchart of an image classification model training method according to an embodiment of this application;

FIG. 14 is a schematic diagram of a principle for an image classification method according to an embodiment of this application;

FIG. 15 is a first schematic diagram of a classification effect of an image classification method according to an embodiment of this application; and

FIG. 16 is a second schematic diagram of a classification effect of an image classification method according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

“Some embodiments” involved in the following description describe a subset of all possible embodiments. However, “some embodiments” may be the same or different subsets of all the possible embodiments, and may be combined with each other when there is no conflict.

In the following description, the terms “first”, “second”, and “third” are merely intended to distinguish between similar objects and do not indicate a specific sequence of the objects. A specific order or sequence of the “first”, “second”, and “third” may be interchanged if permitted, so that the embodiments of this application described herein may be implemented in a sequence other than the sequence illustrated or described herein.

Unless otherwise defined, meanings of all technical and scientific terms used in this specification are the same as those usually understood by a person skilled in the art to which this application belongs. The terms used in this specification are merely intended to describe the objectives of the embodiments of this application, but are not intended to limit this application.

Before the embodiments of this application are further described in detail, nouns and terms in the embodiments of this application are described, and the nouns and terms in the embodiments of this application are applicable to the following explanations.

(1) Artificial intelligence (AI): AI is a comprehensive discipline, and relates to a wide range of fields including both hardware technologies and software technologies. Basic artificial intelligence technologies generally include technologies related to sensors, dedicated artificial intelligence chips, cloud computing, distributed storage, big data processing, pre-trained models, operating/interaction systems, electromechanical integration, and the like. A pre-trained model is also referred to as a big model or a basic model, and may be widely used in downstream tasks in various directions of artificial intelligence after fine-tuning. AI software technologies mainly include several major directions such as a computer vision technology, a speech processing technology, a natural language processing technology, and machine learning/deep learning.

(2) Computer vision (CV) technology: Computer vision is a field of science that studies how to enable a machine to “see”, to be specific, use a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. Large model technologies transform development of computer vision technologies. Pre-trained models in vision fields such as swin-transformers, ViT, V-MOE, and MAE can be quickly and widely applied to specific downstream tasks after fine-tuning. The computer vision technology generally includes technologies such as image processing, image recognition, image semantic understanding, image retrieval, OCR, video processing, video semantic understanding, video content/behavior recognition, three-dimensional object reconstruction, a 3D technology, virtual reality, augmented reality, synchronous positioning, and map construction, and further includes common biometric recognition technologies such as face recognition and fingerprint recognition.

(3) Machine learning (ML): ML is an interdisciplinary field, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI and is the basic way to make computers intelligent, and is applied to various fields of AI. ML and deep learning generally include technologies such as an artificial neural network, a belief network, reinforcement learning, transfer learning, inductive learning, and few-shot learning. A pre-trained model is a latest development result of deep learning, and combines the foregoing technologies.

(4) A convolutional neural network (CNN): CNN is a type of feedforward neural network (FNN) including convolutional computation and having a deep structure, and is one of representative algorithms of deep learning. The convolutional neural network has a representation learning capability, and can perform shift-invariant classification on an input image according to a hierarchical structure thereof.

(5) “In response to”: This is used to represent a condition or status on which a to-be-performed operation depends. When the condition or status is met, one or more operations may be performed immediately or have a specified delay. Unless otherwise specified, a chronological order between a plurality of to-be-performed operations is not limited.

(6) Convolutional layer: Each Convolutional layer in the convolutional neural network is formed by a plurality of convolutional units, and a parameter of each convolutional unit is obtained through optimization by using a back propagation algorithm. An objective of the convolution operation is to extract different features of an input. The first convolutional layer may be only capable of extracting some low-level features such as edges, lines, and corners. Higher-layer networks can iteratively extract more complex features from the low-level features.

(7) Pooling layer: After the convolutional layer performs encoding, an outputted feature map is transferred to the pooling layer for feature selection and information filtering. The pooling layer includes a preset pooling function, to replace a result of a single point in the feature map with a feature map statistic of an adjacent area thereof. The operation of selecting a pooling area by the pooling layer is the same as that of scanning the feature map by a convolutional kernel, and depends on a pooling size, a step size, and filling.

(8) Fully-connected layer: The fully-connected layer in the convolutional neural network is equivalent to a hidden layer in a conventional feedforward neural network. The fully-connected layer is located in the last part of a hidden layer of a convolutional neural network, and transfers a signal only to another fully-connected layer. The feature map loses a spatial topology structure in the fully-connected layer, and is expanded into a vector and an activation function is executed on the vector.

(9) Immune receptor: The immune system is one of the most important life maintenance systems in an organism, and can detect and eliminate pathogens and abnormal cells in the body. Main components of the immune system are white blood cells and molecules closely related to white blood cells. The immune receptor is an important part of the immune system, and is a type of protein specifically designed to recognize and bind to antigen molecules. The immune receptor mainly functions to detect and bind to an antigen, which is a key operation for the immune system to recognize and eliminate pathogens or abnormal cells in the body. The immune receptor also functions to regulate an immune response, and the immune response needs to be performed at an appropriate moment and extent, to avoid damage to host tissues. The immune receptor is a type of protein that can recognize and bind to antigen molecules, and includes a T-cell receptor and a B-cell receptor, and mainly functions to detect and eliminate pathogens and abnormal cells in the body, and may also regulate duration and strength of an immune response and maintain immune balance.

(10) Immune repertoire (IR): IR is also referred to as an immune receptor repertoire, and is a comprehensive combination of all functionally diversified T cells and B cells in the immune system of a biological individual at a time. Diversity of the immune repertoire is specifically reflected in diversity of B-cell receptors (BCR) or T-cell receptors (TCR) formed by permutations and combinations of V, D, J, and C gene segments. The BCR includes two heavy chains and two light chains, and the TCR includes a and B chains. The human immune system consists of innate immunity and adaptive immunity. Adaptive immunity is that after T cells and B cells come in contact with a pathogen (an antigen), an immune response that can recognize and eliminate a particular pathogen is generated. An adaptive immune receptor repertoire (an immune repertoire for short) is a set of T cell receptors (TCR) or B cell receptors (BCR), and records past and ongoing adaptive immune responses. A status of the immune repertoire may be used to reflect an immune activity status and responses of an individual to an infective illness, an immune illness of the individual, and a tumor-associated pathogen. A massive adaptive immune receptor repertoire (AIRR) includes a set of massive adaptive immune receptors (a collective name of AIR, TCR, and BCR). Assuming that there are N AIRRs, a mathematical expression thereof is {IR₁, IR₂, . . . , IR_{N}}. Each AIRR includes M AIRs, which are represented as

$$\{ {IR}_{i}^{1} , {IR}_{i}^{2} , … , {IR}_{i}^{M} \} .$$

M in immune repertoires of different individuals varies greatly. In addition, labels of the N immune repertoires are defined as {Y₁, Y₂, . . . , Y_{N}}, where Y∈{0, . . . , C}, and C represents a quantity of categories. For example, in a case of binary classification, C=1. In addition, each AIR has a corresponding frequency, which is represented as

$$\{ {F}_{i}^{1} , {f}_{i}^{2} , … , {f}_{i}^{M} \} .$$

The frequency indicates strength of an immune response to a particular antigen. In this embodiment of this application, a mapping function Y=F(IR) may be established, to convert the immune repertoire (IR) to an immune status Y.

(11) Gene: Gene is a complete nucleotide sequence required to produce a polypeptide chain or a functional RNA. Gene supports the basic structure and performance of life, and stores all information about life. Environment and genetics are interdependent, and important physiological processes such as the reproduction of life, cell division, and protein synthesis unfold. All life phenomena such as birth, growth, decline, sickness, aging, and death of an organism are related to genes. Genes are also an internal factor that determines life and health. Therefore, genes have two attributes: material (existence manner) and informative (intrinsic attribute).

(12) Modal: Modal usually refers to a single perception or expression manner, and may refer to any single information transfer or interaction manner. In the fields of information technologies, human-computer interaction, and communications, modalities may refer to different information expression forms such as text, image, sound, and touch. For example, in a communication process, a language (oral or written) may be considered as a modality. The modality emphasizes a single information or interaction channel, for example, communication is performed only by words.

(13) Multimodal: Multimodal refers to an information processing or interaction manner related to two or more different modalities. In the multimodal interaction, information may be simultaneously or sequentially transferred through a plurality of perceptual channels, for example, in a plurality of manners such as visual (an image and a video), auditory (voice and music), and tactile (vibration and pressure). The multimodal interaction aims to improve information transfer efficiency and accuracy and user experience by using advantages of different modalities.

(14) Medical image: A medical image is an image that is captured by using a specific imaging technology and that includes medical information. The medical image is usually configured to record and analyze a physiological feature, a structural attribute, or a behavior mode of a medical entity. Medical information included in a medical image is diverse, and may be a macrostructure of a medical entity, such as a body shape, a color, or a texture, or may be a microstructure, such as a cell structure, an arrangement, a chemical molecular structure, or a medicinal molecular structure. In the field of medical recognition, common medical information includes, but is not limited to, a palm print, a fingerprint, an iris, a facial feature, an amino acid molecular structure, a cellular molecular structure, a chemical molecular structure, a medicinal molecular structure, and the like. A category of a to-be-classified image may be used to indicate a category of medical information included in the to-be-classified image.

In an implementation process of embodiments of this application, the applicant finds that the related art has the following problems:

Refer to Table 1 below. Table 1 is a schematic table of comparison between performance of embodiments of this application and performance of related technologies on a data set 1 and a data set 2 respectively.

TABLE 1
Schematic table of comparison between performance
of embodiments of this application and performance
of related technologies

| | Technical | Indica- | Indica- | Indica- |
|---|---|---|---|---|
| Data set | route | tor 1 | tor 2 | tor 3 |
| Data set | This | 84.88 | 78.80 | 78.56 |
| 1 | application | | | |
| | Related | 83.10 | 72.6 | 72.7 |
| | technology | | | |
| | 1 | | | |
| | Related | 67.0 | 65.2 | 72.2 |
| | technology | | | |
| | 2 | | | |
| Data set | This | 90.22 | 83.0 | 80.59 |
| 2 | application | | | |
| | Related | 86.6 | 79.6 | 72.4 |
| | technology | | | |
| | 1 | | | |
| | Related | 89.03 | 80.13 | 78.79 |
| | technology | | | |
| | 2 | | | |

As can be known from the foregoing table, this application significantly outperforms the related technology 1 and the related technology 2 in all the indicators. In related-art information classification, a to-be-classified image is usually classified directly based on a to-be-classified vector of the to-be-classified image, to obtain a category of the to-be-classified image. Because a plurality of to-be-classified sub-images included in the to-be-classified image affect the category of the to-be-classified image, and a single-modality to-be-classified image corresponds to a relatively low information amount, information classification accuracy is relatively low.

The embodiments of this application provide an image classification method and apparatus, an electronic device, a computer-readable storage medium, and a computer program product, to effectively improve information classification accuracy. The following describes exemplary application of an information classification system provided in the embodiments of this application.

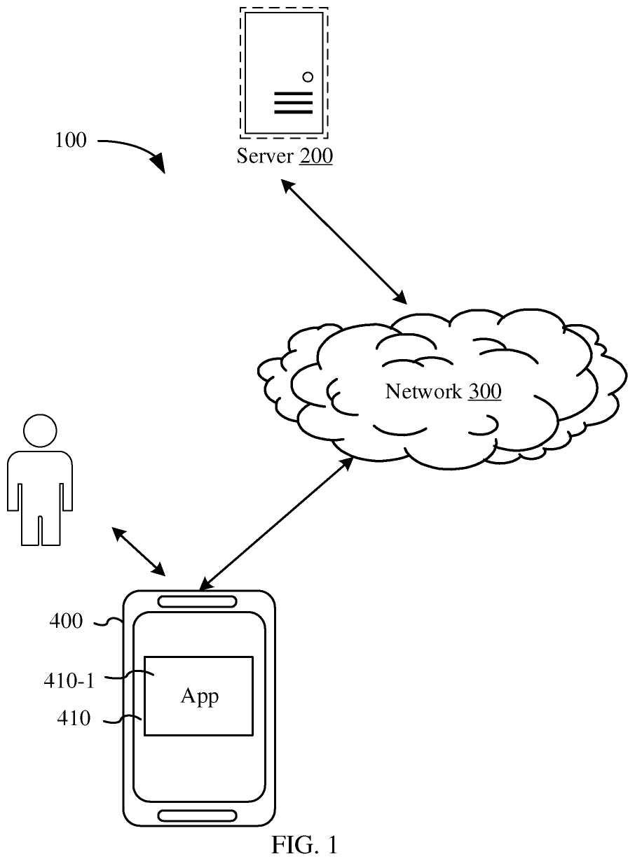

FIG. 1 is a schematic architectural diagram of an information classification system 100 according to an embodiment of this application. A terminal (exemplarily, a terminal 400 is shown) is connected to a server 200 through a network 300. The network 300 may be a wide area network, a local area network, or a combination of the two.

The terminal 400 is configured to allow a user to use a client 410, and display a category of a to-be-classified image on a graphic interface 410-1 (exemplarily, the graphic interface 410-1 is shown). The terminal 400 and the server 200 are connected to each other through a wired or wireless network.

In some embodiments, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400 may be a smartphone, a tablet computer, a notebook computer, a desktop computer, a smart speaker, a smart television, a smartwatch, an in-vehicle terminal, or the like, but is not limited thereto. The electronic device provided in the embodiments of this application may be implemented as a terminal, or may be implemented as a server. The terminal and the server may be connected directly or indirectly in a wired or wireless communication protocol, which is not limited in the embodiments of this application.

In some embodiments, the server 200 obtains a to-be-classified image, converts the to-be-classified image between different modalities, to obtain modality information, encodes the to-be-classified image based on the modality information, to obtain a to-be-classified vector, performs category prediction on a to-be-classified sub-image based on a to-be-classified sub-vector, to obtain a category prediction probability, classifies the to-be-classified image based on all category prediction probabilities, to obtain a category of the to-be-classified image, and sends the category to the terminal 400.

In some other embodiments, the terminal 400 obtains a to-be-classified image, converts the to-be-classified image between different modalities, to obtain modality information, encodes the to-be-classified image based on the modality information, to obtain a to-be-classified vector, performs category prediction on a to-be-classified sub-image based on a to-be-classified sub-vector, to obtain a category prediction probability, classifies the to-be-classified image based on all category prediction probabilities, to obtain a category of the to-be-classified image, and sends the category to the server 200.

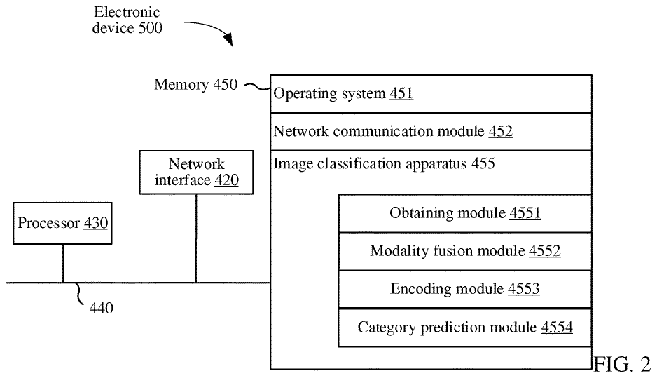

FIG. 2 is a schematic structural diagram of an electronic device 500 for information classification according to an embodiment of this application. The electronic device 500 shown in FIG. 2 may be the server 200 or the terminal 400 shown in FIG. 1. The electronic device 500 shown in FIG. 2 includes at least one processor 430, a memory 450, and at least one network interface 420. Components in the electronic device 500 are coupled together by using a bus system 440. The bus system 440 is configured to implement connection and communication between the components. In addition to a data bus, the bus system 440 further includes a power bus, a control bus, and a state signal bus. However, for ease of clear description, all types of buses are marked as the bus system 440 in FIG. 2.

The processor 430 may be an integrated circuit chip having a signal processing capability, such as a general-purpose processor, a digital signal processor (DSP) or another programmable logic device, a discrete gate or transistor logic device, a discrete hardware component, or the like. The general-purpose processor may be a microprocessor or any conventional processor.

The memory 450 may be a removable memory, an irremovable memory, or a combination of the two. Exemplary hardware devices include a solid-state memory, a hard disk drive, an optical disk drive, and the like. In an embodiment, the memory 450 includes one or more storage devices physically located away from the processor 430.

The memory 450 includes a volatile memory or a non-volatile memory, or may include both a volatile memory and a non-volatile memory. The non-volatile memory may be a read-only memory (ROM), and the volatile memory may be a random-access memory (RAM). The memory 450 described in the embodiments of this application aims to include any suitable type of memories.

In some embodiments, the memory 450 can store data to support various operations. Examples of the data include a program, a module, and a data structure, or a subset or a superset thereof, which are exemplarily described below.

An operating system 451 includes system programs configured for processing various basic system services and performing hardware-related tasks, for example, a framework layer, a kernel library layer, and a driver layer, and is configured to implement various basic services and process hardware-based tasks.

A network communication module 452 is configured to reach another electronic device through one or more (wired or wireless) network interfaces 420. An exemplary network interface 420 includes Bluetooth, wireless fidelity (Wi-Fi), a universal serial bus (USB), and the like.

In some embodiments, the image classification apparatus provided in the embodiments of this application may be implemented by software. FIG. 2 shows an image classification apparatus 455 stored in the memory 450. The apparatus may be software in a form of a program and a plug-in, and includes the following software modules: an obtaining module 4551, a modality fusion module 4552, an encoding module 4553, and a category prediction module 4554. The modules are logical and may be combined in different manners or further split based on to-be-implemented functions. Functions of the modules are described below.

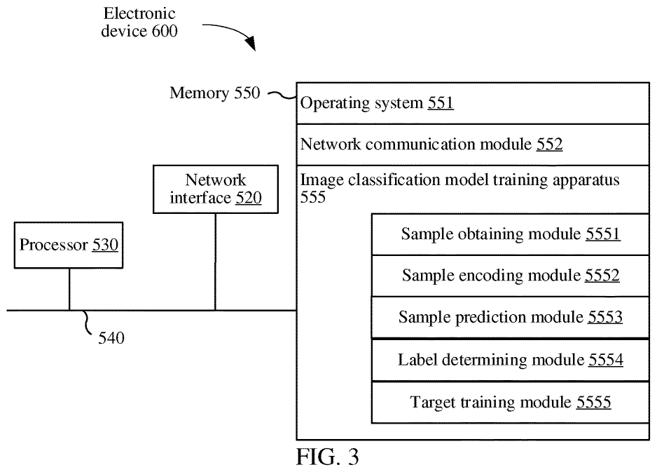

FIG. 3 is a schematic structural diagram of an electronic device 600 for training an image classification model according to an embodiment of this application. The electronic device 600 shown in FIG. 3 may be the server 200 or the terminal 400 shown in FIG. 1. The electronic device 600 shown in FIG. 3 includes at least one processor 530, a memory 550, and at least one network interface 520. Components in the electronic device 600 are coupled together by using a bus system 540. The bus system 540 is configured to implement connection and communication between the components. In addition to a data bus, the bus system 540 further includes a power bus, a control bus, and a state signal bus. However, for ease of clear description, all types of buses are marked as the bus system 540 in FIG. 3.

The processor 530 may be an integrated circuit chip having a signal processing capability, such as a general-purpose processor, a digital signal processor (DSP) or another programmable logic device, a discrete gate or transistor logic device, a discrete hardware component, or the like. The general-purpose processor may be a microprocessor or any conventional processor.

The memory 550 may be a removable memory, an irremovable memory, or a combination of the two. Exemplary hardware devices include a solid-state memory, a hard disk drive, an optical disk drive, and the like. In an embodiment, the memory 550 includes one or more storage devices physically located away from the processor 530.

The memory 550 includes a volatile memory or a non-volatile memory, or may include both a volatile memory and a non-volatile memory. The non-volatile memory may be a read-only memory (ROM), and the volatile memory may be a random-access memory (RAM). The memory 550 described in the embodiments of this application aims to include any suitable type of memories.

In some embodiments, the memory 550 can store data to support various operations. Examples of the data include a program, a module, and a data structure, or a subset or a superset thereof, which are exemplarily described below.

An operating system 551 includes system programs configured for processing various basic system services and performing hardware-related tasks, for example, a framework layer, a kernel library layer, and a driver layer, and is configured to implement various basic services and process hardware-based tasks.

A network communication module 552 is configured to reach another electronic device through one or more (wired or wireless) network interfaces 520. An exemplary network interface 520 includes Bluetooth, wireless fidelity (Wi-Fi), a universal serial bus (USB), and the like.

In some embodiments, the image classification model training apparatus provided in the embodiments of this application may be implemented by software. FIG. 3 shows an image classification model training apparatus 555 stored in the memory 550. The apparatus may be software in a form of a program and a plug-in, and includes the following software modules: a sample obtaining module 5551, a sample encoding module 5552, a sample prediction module 5553, a label determining module 5554, and a target training module 5555. The modules are logical and may be combined in different manners or further split based on to-be-implemented functions. Functions of the modules are described below.

In some other embodiments, the image classification model training apparatus provided in the embodiments of the application may be implemented by hardware. As an example, the image classification model training apparatus provided in the embodiments of the application may be a processor in the form of a hardware decoding processor, which is programmed to perform the image classification model training method provided in the embodiments of the application. For example, the processor in the form of a hardware decoding processor may be one or more application specific integrated circuits (ASIC), a DSP, a programmable logic device (PLD), a complex programmable logic device (CPLD), a field-programmable gate array (FPGA), or another electronic component.

In some embodiments, the terminal or the server may implement the image classification method provided in the embodiments of this application by running computer programs or computer-executable instructions. For example, the computer program may be a native program (for example, a dedicated program for information classification) or a software module in an operating system, for example, an information classification module that may be embedded in any program (for example, an instant messaging client, an album program, an electronic map client, or a navigation client), or may be a native application (APP), that is, a program that needs to be installed in the operating system for running. In conclusion, the computer program may be any form of an application, a module, or a plug-in.

In some embodiments, the embodiments of this application may be implemented in the following manner: obtaining to-be-classified information including a plurality of pieces of to-be-classified sub-information, and converting the to-be-classified information between different modalities, to obtain modality information of the to-be-classified information that corresponds to each modality; performing modality fusion on all pieces of modality information, to obtain a multimodal vector corresponding to the to-be-classified information; encoding the to-be-classified information based on the multimodal vector, to obtain a to-be-classified sub-vector in a one-to-one correspondence with each piece of to-be-classified sub-information; and classifying the to-be-classified information based on the to-be-classified sub-vector corresponding to each piece of to-be-classified sub-information, to obtain the category of the to-be-classified information.

In some embodiments, the to-be-classified information may be a to-be-classified image. In the following description, for example, the to-be-classified information is a to-be-classified image, and the image classification method provided in the embodiments of this application is described.

The image classification method provided in the embodiments of this application is described with reference to the exemplary application and implementations of the server or the terminal provided in the embodiments of this application.

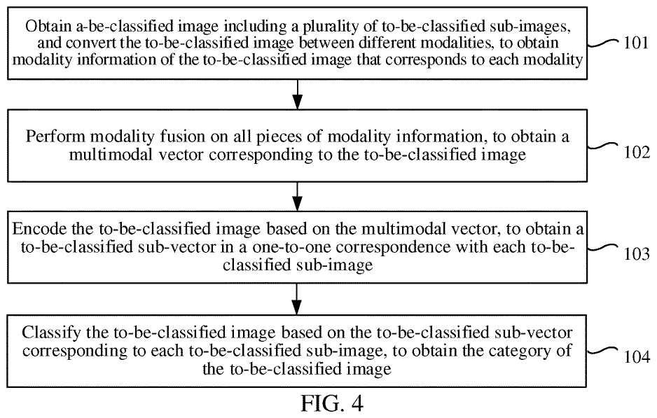

FIG. 4 is a first schematic flowchart of an image classification method according to an embodiment of this application. The method is described with reference to operation 101 to operation 104 shown in FIG. 4. The image classification method provided in the embodiments of this application may be implemented by a server or a terminal alone, or may be cooperatively implemented by a server and a terminal. The following describes an example in which the method is implemented by a server alone.

Operation 101: Obtain a to-be-classified image including a plurality of to-be-classified sub-images, and convert the to-be-classified image between different modalities, to obtain modality information of the to-be-classified image that corresponds to each modality.

In some embodiments, the to-be-classified image includes a plurality of to-be-classified sub-images, and the to-be-classified sub-images are composition elements of the to-be-classified image. For example, a to-be-classified image A includes a to-be-classified sub-image A1, a to-be-classified sub-image A2, and a to-be-classified sub-image A3.

In some embodiments, the modality is used for indicating an information perceptual channel, and information perceptual channels corresponding to different modality information are different. For example, an information perceptual channel corresponding to video modality information in a video modality is a video, and an information perceptual channel corresponding to audio modality information in an audio modality is an audio. The modality conversion is a processing process of converting the to-be-classified image in an original modality to modality information in a target modality.

In some embodiments, the converting the to-be-classified image between different modalities, to obtain modality information of the to-be-classified image that corresponds to each modality may be implemented in the following manner: when the to-be-classified image is multimodality information, obtaining each target modality of the to-be-classified image, and extracting, for each target modality, modality information in the target modality from the to-be-classified image, to obtain modality information of the to-be-classified image that corresponds to the target modality; or when the to-be-classified image is single-modality information, obtaining a plurality of target modalities, and for each target modality, converting the to-be-classified image to the target modality, to obtain modality information of the to-be-classified image that corresponds to the target modality.

As an example, in an application scenario of text classification, the to-be-classified image may be obtained by performing image conversion on a to-be-classified text (single-modality information). The to-be-classified text includes a plurality of to-be-classified subtexts. For example, the to-be-classified text is “fingerprint is threaded, and coordinates of a start point, an end point, a branch, and an intersection of cristae cutis are respectively: . . . ”. In this case, the plurality of to-be-classified subtexts included in the to-be-classified text may be “threaded”, “coordinates of a start point of cristae cutis”, “coordinates of an end point”, “coordinates of a branch”, and the like. A to-be-classified medical image is converted to an audio modality, to obtain a to-be-classified audio in the audio modality corresponding to the to-be-classified image; and the to-be-classified image is converted to a text modality, to obtain a to-be-classified text in the text modality corresponding to the to-be-classified image.

As an example, in an application scenario of a to-be-classified immune receptor repertoire, the to-be-classified image may be an image including a to-be-classified immune receptor repertoire. The to-be-classified immune receptor repertoire includes a plurality of immune receptors, different immune receptors correspond to different image areas in the to-be-classified image, and an image area corresponding to an immune receptor is a to-be-classified sub-image in the to-be-classified image. The to-be-classified immune receptor repertoire in the to-be-classified image is converted to an amino acid sequence modality, to obtain modality information of an amino acid sequence of the to-be-classified immune receptor repertoire in an amino acid sequence modality. The to-be-classified immune receptor repertoire in the to-be-classified image is converted to a gene segment modality, to obtain modality information of gene segments of the to-be-classified immune receptor repertoire in the gene segment modality.

As an example, in an application scenario of video classification, the to-be-classified image may be obtained by combining a plurality of to-be-classified video frames in a to-be-classified video (multimodality information), and the to-be-classified image includes the plurality of to-be-classified video frames. For example, the to-be-classified image is converted to an audio modality, to obtain a to-be-classified audio in the audio modality corresponding to the to-be-classified image; and the to-be-classified image is converted to a video modality, to obtain a to-be-classified video in the video modality corresponding to the to-be-classified image.

As an example, in an application scenario of video classification, a to-be-classified medical image including a plurality of to-be-classified video frames is obtained, the to-be-classified image is converted between different modalities, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image, where the to-be-classified vector includes a to-be-classified sub-vector in a one-to-one correspondence with each to-be-classified video frame; category prediction is performed on each to-be-classified video frame based on the to-be-classified sub-vector corresponding to the to-be-classified video frame, to obtain a category prediction probability of the to-be-classified video frame; and the to-be-classified image is classified based on the category prediction probability corresponding to each to-be-classified video frame, to obtain a category of the to-be-classified image.

As an example, in an application scenario of an immune receptor repertoire, a to-be-classified image of a to-be-classified immune receptor repertoire that includes a plurality of to-be-classified immune receptors is obtained, the to-be-classified image is converted between different modalities including the to-be-classified immune receptor repertoire, to obtain modality information of the to-be-classified immune receptor repertoire that corresponds to each modality; modality fusion is performed on all pieces of modality information, to obtain a multimodal vector corresponding to the to-be-classified immune receptor repertoire; the to-be-classified immune receptor repertoire is encoded based on the multimodal vector, to obtain a to-be-classified vector corresponding to the to-be-classified immune receptor repertoire, where the to-be-classified vector includes a to-be-classified sub-vector in a one-to-one correspondence with each to-be-classified immune receptor; category prediction is performed on each to-be-classified immune receptor based on the to-be-classified sub-vector corresponding to each to-be-classified immune receptor, to obtain a category prediction probability of the to-be-classified immune receptor; and the to-be-classified image including to-be-classified immune receptor repertoire is classified based on the category prediction probability corresponding to each to-be-classified immune receptor, to obtain a category of the to-be-classified immune receptor repertoire.

In some embodiments, the to-be-classified image of the to-be-classified immune receptor repertoire that includes the plurality of to-be-classified immune receptors is a to-be-classified medical image. A medical image is an image that is captured by using a specific imaging technology and that includes medical information. The medical image is usually configured for recording and analyzing a physiological feature, a structural attribute, or a behavior mode of a medical entity. Medical information included in a medical image is diverse, and may be a macrostructure of a medical entity, such as a body shape, a color, or a texture, or may be a microstructure, such as a cell structure, an arrangement, a chemical molecular structure, or a medicinal molecular structure. In the field of medical recognition, common medical information includes, but is not limited to, a palm print, a fingerprint, an iris, a facial feature, an amino acid molecular structure, a cellular molecular structure, a chemical molecular structure, a medicinal molecular structure, and the like. A category of a to-be-classified image may be used to indicate a category of medical information included in the to-be-classified image.

As an example, in an application scenario of text classification, a to-be-classified medical text including a plurality of to-be-classified medical subtexts is obtained, the to-be-classified medical text is converted to a to-be-classified image, the to-be-classified image is converted between different modalities, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image, where the to-be-classified vector includes a to-be-classified sub-vector in a one-to-one correspondence with each to-be-classified sub-image; category prediction is performed on each to-be-classified sub-image based on the to-be-classified sub-vector corresponding to each to-be-classified sub-image, to obtain a category prediction probability of the to-be-classified sub-image; and the to-be-classified image is classified based on the category prediction probability corresponding to each to-be-classified sub-image, to obtain a category of the to-be-classified image.

In this way, the to-be-classified image including the plurality of to-be-classified sub-images is obtained, and the to-be-classified image is converted between different modalities, to obtain the modality information of the to-be-classified image that corresponds to each modality, thereby implementing modality conversion on the to-be-classified image. Therefore, multi-dimensional portrayal can be performed on the to-be-classified image from a plurality of different modality dimensions, thereby effectively enhancing an information amount of the to-be-classified image.

Operation 102: Perform modality fusion on all pieces of modality information, to obtain a multimodal vector corresponding to the to-be-classified image.

In some embodiments, the modality fusion refers to a processing process of converting multiple pieces of modality information to a multimodal vector.

In some embodiments, the modality fusion refers to a process of integrating information in different modalities (for example, text, image, and audio) in a multimodal data processing system. Each modality usually includes a different aspect or feature of data, and the objective of modality fusion is to combine these different information sources, to obtain a more comprehensive and diverse data representation.

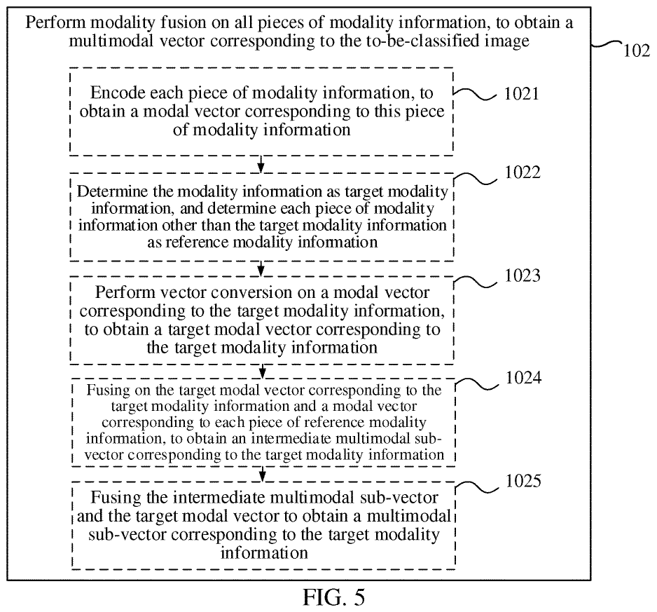

In some embodiments, the multimodal vector includes a multimodal sub-vector corresponding to each piece of modality information. FIG. 5 is a second schematic flowchart of an image classification method according to an embodiment of this application. Operation 102 shown in FIG. 4 is implemented through operation 1021 to operation 1025 in FIG. 5.

Operation 1021: Encode each piece of modality information, to obtain a modal vector corresponding to this piece of modality information.

In some embodiments, operation 1021 may be implemented in the following manner: invoking an encoding layer for each piece of modality information to encode the modality information to obtain the modal vector corresponding to the modality information.

In some embodiments, the encoding layer includes a convolutional layer, the convolutional layer is formed by a plurality of convolutional units, and a parameter of each convolutional unit is obtained through optimization by using a back propagation algorithm. An objective of the convolution operation is to extract different features of an input. The first convolutional layer may be only capable of extracting some low-level features such as edges, lines, and corners. Higher-layer networks can iteratively extract more complex features from the low-level features.

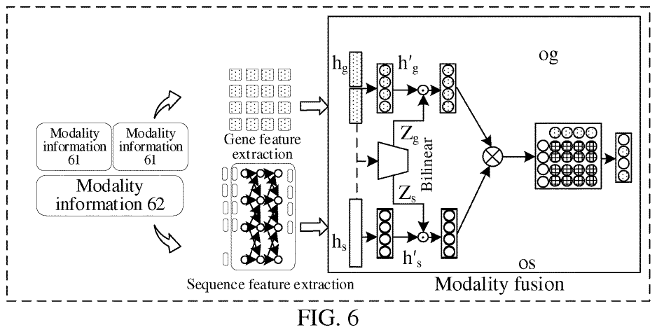

As an example, FIG. 6 is a schematic diagram of a principle for modality fusion according to an embodiment of this application. Modality information 61 shown in FIG. 6 is genetic modality information, and modality information 62 shown in FIG. 6 is sequence modality information. The modality information 61 is encoded, to obtain a modal vector h_{g} corresponding to the modality information 61. The modality information 62 is encoded, to obtain a modal vector hₛ corresponding to the modality information 62.

In some embodiments, after operation 1021, the following operation 1022 to operation 1025 may be performed on each piece of modality information.

Operation 1022: Determine the modality information as target modality information, and determine each piece of modality information other than the target modality information as reference modality information.

As an example, modality information of the to-be-classified image that corresponds to all modalities includes modality information A, modality information B, and modality information C. When processing is performed on the modality information A, the modality information A is determined as the target modality information, and modality information (the modality information B and the modality information C) other than the target modality information A is determined as the reference modality information.

As another example, when processing is performed on the modality information B, the modality information B is determined as the target modality information, and modality information (the modality information A and the modality information C) other than the target modality information B is determined as the reference modality information.

As another example, when processing is performed on the modality information C, the modality information C is determined as the target modality information, and modality information (the modality information A and the modality information B) other than the target modality information C is determined as the reference modality information.

As an example, referring to FIG. 6, when processing is performed on the modality information 61, the modality information 61 is determined as target modality information, and the modality information 62 is determined as reference modality information.

As an example, referring to FIG. 6, when processing is performed on the modality information 62, the modality information 62 is determined as target modality information, and the modality information 61 is determined as reference modality information.

Operation 1023: Perform vector conversion on a modal vector corresponding to the target modality information, to obtain a target modal vector corresponding to the target modality information.

In some embodiments, the vector conversion is also referred to as feature linear transformation, and refers to a processing process of performing linear transformation on a to-be-processed feature (a modal vector), to obtain a converted modal vector (a target modal vector).

In some embodiments, vector conversion refers to a process of performing a series of mathematical operations on a to-be-processed feature (that is, a modal vector), to change a form or a spatial position of the feature to obtain a new vector representation (that is, a target modal vector) in the field of data processing and machine learning. This process usually involves linear transformation in linear algebra and may help improve data divisibility, reduce dimensions, or adapt to a specific model requirement.

As an example, referring to FIG. 6, when the target modality information is the modality information 61, vector conversion is performed on a modal vector h_{g} corresponding to the modality information 61, to obtain a target modal vector h_{g} corresponding to the target modality information 61.

As an example, referring to FIG. 6, when the target modality information is the modality information 62, vector conversion is performed on a modal vector hₛ corresponding to the modality information 62, to obtain a target modal vector h′ₛ corresponding to the target modality information 62.

In some embodiments, operation 1023 may be implemented in the following manner: obtaining a target conversion vector corresponding to the target modality information and a target correction vector corresponding to the target modality information, where a vector dimension of the modal vector corresponding to the target modality information is the same as both vector dimensions of the corresponding target conversion vector and the corresponding target correction vector; multiplying the modal vector corresponding to the target modality information by the target conversion vector, to obtain a converted modal vector corresponding to the target modality information; adding the target conversion vector and the target correction vector, to obtain an intermediate target modal vector corresponding to the target modality information; and performing vector activation on the target correction vector, to obtain the target modal vector corresponding to the target modality information.

As an example, referring to FIG. 6, when the target modality information is the modality information 61, an expression of the target modal vector corresponding to the target modality information may be:

$${h}_{g}^{′} = R e L u ( {W}_{g} * {h}_{g} + {b}_{g} ) \qquad ( 1 )$$

where

$${h}_{g}^{′}$$

is configured for indicating a target modal vector corresponding to the modality information 61, h_{g} is configured for indicating a modal vector corresponding to the modality information 61, W_{g} is configured for indicating a target conversion vector, and b_{g} is configured for indicating a target correction vector.

As an example, referring to FIG. 6, when the target modality information is the modality information 62, an expression of the target modal vector corresponding to the target modality information may be:

$${h}_{g}^{′} = R e L u ( {W}_{s} * {h}_{g} + {b}_{s} ) \qquad ( 2 )$$

where

$${h}_{g}^{′}$$

is configured for indicating a target modal vector corresponding to the modality information 62, h_{g} is configured for indicating a modal vector corresponding to the modality information 62, W_{g} is configured for indicating a target conversion vector, and b_{g} is configured for indicating a target correction vector.

In some embodiments, vector activation refers to a process of applying a nonlinear function to a vector in machine learning and deep learning, and aims to increase a nonlinear capability of a model, thereby improving an approximation capability of the model to a complex function. In a scenario described in the context, vector activation refers to obtaining a target conversion vector and a target correction vector that correspond to target modality information and then performing nonlinear transformation on the vectors, to obtain a final target modal vector.

As an example, in a speech recognition system, an audio signal needs to be converted to a text. It is hoped that representation of audio features can be optimized through vector conversion and correction. A conversion matrix is designed to map an original 128-dimensional MFCC vector to a new feature space. The conversion matrix is also 128-dimensional, because it is hoped that a dimension of a feature is kept unchanged, so as to facilitate subsequent processing. A 128-dimensional intermediate target modal vector is further defined. The vector is configured to fine-tune a converted feature, to compensate for possibly lost information in a conversion process or enhance some particular features. The 128-dimensional modal vector is multiplied by the 128-dimensional target conversion matrix. The multiplication operation converts an original audio feature to a new feature space, to generate a 128-dimensional converted modal vector. The converted modal vector may better represent a speech signal, making it more suitable for a subsequent recognition task. The target conversion vector and the target correction vector are added, to obtain a 128-dimensional intermediate target modal vector. This intermediate target modal vector combines a mapping effect of the conversion matrix and a fine-tuning effect of the intermediate target modal vector. Vector activation is performed on the intermediate target modal vector. This process may include applying a non-linear function such as a ReLU function or a Sigmoid function, to further optimize feature representation. The activated vector, that is, the target modal vector, not only includes original audio information, but also integrates additional information obtained through conversion and correction. The final target modal vector is used as an input of a voice recognition model, to improve recognition accuracy.

In this way, the target conversion vector and the target correction vector that correspond to the target modality information are obtained, and it is ensured that dimensions of these vectors are the same as a dimension of the modal vector corresponding to the target modality information. Therefore, a series of data processing operations can be performed to optimize and improve representation of the modality information. First, the modal vector corresponding to the target modality information is multiplied by the target conversion vector. This operation can effectively map the original feature into a new feature space, to generate the converted modal vector corresponding to the target modality information. This vector may better reflect an internal structure and relationship of data. Next, the target conversion vector and the target correction vector are added, to obtain an intermediate target modal vector. This intermediate target modal vector is obtained by considering an additional adjustment factor, and may fine-tune or compensate for the original feature. Finally, vector activation is performed on the intermediate target modal vector, which is a type of nonlinear transformation and can further optimize a feature representation form. A finally obtained target modal vector not only includes original modality information, but also integrates converted and corrected information. This processing procedure significantly improves a capability of representing a target task by the modal vector, thereby helping improve model performance and prediction accuracy.

Operation 1024: Perform vector fusion on the modal vector corresponding to the target modality information and a modal vector corresponding to each piece of reference modality information, to obtain a intermediate multimodal sub-vector corresponding to the target modality information.

In some embodiments, the vector fusion includes linear fusion and non-linear fusion. The vector fusion refers to a processing process of fusing a plurality of to-be-fused features to obtain at least one fused feature.

In some embodiments, vector fusion is a feature fusion technology, and relates to a process of combining a plurality of eigenvectors of different sources or different dimensions into one or more new eigenvectors. Vector fusion is configured to combine a plurality of independent eigenvectors into one single eigenvector, or fuse a plurality of eigenvectors into a new group of eigenvectors. There are two main types: linear fusion and non-linear fusion. Linear fusion refers to combining a plurality of eigenvectors in a linear combination manner. Common linear fusion methods include weighted averaging, principal component analysis (PCA), linear discriminant analysis (LDA), and the like. During linear fusion, each original eigenvector is converted through linear transformation (for example, a weight matrix), and then a fused eigenvector is obtained through linear combination. Non-linear fusion relates to combining a plurality of eigenvectors by using a non-linear function. This fusion manner can better capture a complex relationship between features. Common non-linear fusion methods include a neural network, a deep learning model, a kernel function method, and the like.

In some embodiments, operation 1024 may be implemented in the following manner: obtaining a reference conversion vector corresponding to the target modality information and a reference correction vector corresponding to the target modality information, where a vector dimension of the modal vector corresponding to the target modality information is the same as both vector dimensions of the corresponding reference conversion vector and the corresponding reference correction vector; performing vector transposition on the modal vector corresponding to the target modality information, to obtain a transposed target modal vector corresponding to the target modality information; multiplying the transposed target modal vector by the corresponding reference conversion vector, to obtain a first reference vector, and multiplying the first reference vector by the modal vector, to obtain a second reference vector; and adding the reference correction vector corresponding to the target modality information and the second reference vector, to obtain the intermediate multimodal sub-vector corresponding to the target modality information.

As an example, referring to FIG. 6, when the target modality information is the modality information 61, an expression of the intermediate multimodal sub-vector corresponding to the target modality information may be:

$${z}_{g} = {h}_{g}^{T} {W}_{g s} {h}_{s} + {b}_{g s} \qquad ( 3 )$$

where z_{g} is configured for indicating a intermediate multimodal sub-vector corresponding to the modality information 61,

$${h}_{g}^{T}$$

is configured for indicating a transposed target modal vector corresponding to the modality information 61, hₛ is configured for indicating a modal vector corresponding to the modality information 62, W_{gs} is configured for indicating a reference conversion vector corresponding to the modality information 61, and b_{gs} is configured for indicating a reference correction vector corresponding to the modality information 61.

As an example, referring to FIG. 6, when the target modality information is the modality information 62, an expression of the intermediate multimodal sub-vector corresponding to the target modality information may be:

$${z}_{s} = {h}_{s}^{T} {W}_{s g} {h}_{g} + {b}_{s g} \qquad ( 4 )$$

where zₛ is configured for indicating a intermediate multimodal sub-vector corresponding to the modality information 62,

$${h}_{s}^{T}$$

is configured for indicating a transposed target modal vector corresponding to the modality information 62, h_{g} is configured for indicating a modal vector corresponding to the modality information 61, W_{sg} is configured for indicating a reference conversion vector corresponding to the modality information 62, and b_{sg} is configured for indicating a reference correction vector corresponding to the modality information 62.

In this way, the reference conversion vector and the reference correction vector corresponding to the target modality information are obtained, and it is ensured that dimensions of these vectors are the same as a dimension of the modal vector corresponding to the target modality information, so that multi-source heterogeneous data can be effectively integrated. Specifically, after the transposition operation is performed on the modal vector corresponding to the target modality information, the transposed target modal vector is multiplied by the reference conversion vector to obtain the first reference vector, then the modal vector is multiplied by the first reference vector to obtain the second reference vector, and finally the reference correction vector and the second reference vector are added, to obtain the intermediate multimodal sub-vector that not only retains core features of the original modality information, but also enhances expression accuracy and robustness through correction and conversion, thereby improving fusion quality of the modality information, and providing more precise and comprehensive input for subsequent data analysis and processing. The model has an enhanced adaptability and generalization capability for complex scenarios, and helps improve performance of prediction and classification tasks. Utilization of data resources is optimized, and waste of computing resources is reduced by using an effective vector operation and fusion policy. This provides a more reliable data basis for subsequent advanced applications such as feature extraction and sentiment analysis.

Operation 1025: Perform vector fusion on the intermediate multimodal sub-vector and the target modal vector, to obtain a multimodal sub-vector corresponding to the target modality information.

As an example, referring to FIG. 6, when the target modality information is the modality information 61, an expression of the multimodal sub-vector corresponding to the target modality information may be:

$${o}_{g} = σ ( {z}_{g} ) * {h}_{g}^{′} \qquad ( 5 )$$

where o_{g} is configured for indicating a multimodal sub-vector corresponding to the modality information 61, z_{g} is configured for indicating a intermediate multimodal sub-vector corresponding to the modality information 61, and

$${h}_{g}^{′}$$

is configured for indicating a target modal vector corresponding to the modality information 61.

As an example, referring to FIG. 6, when the target modality information is the modality information 62, an expression of the multimodal sub-vector corresponding to the target modality information may be:

$${o}_{s} = σ ( {z}_{s} ) * {h}_{s}^{′} \qquad ( 6 )$$

where oₛ is configured for indicating a multimodal sub-vector corresponding to the modality information 62, zₛ is configured for indicating a intermediate multimodal sub-vector corresponding to the modality information 62, and

$${h}_{s}^{′}$$

is configured for indicating a target modal vector corresponding to the modality information 62.

In this way, the multimodal vector corresponding to the to-be-classified image is obtained by performing modality fusion on all pieces of modality information, significantly enhancing an information amount of the obtained multimodal vector, and providing strong data support for subsequently encoding the to-be-classified image based on the multimodal vector.

Operation 103: Encode the to-be-classified image based on the multimodal vector, to obtain a to-be-classified sub-vector in a one-to-one correspondence with each to-be-classified sub-image.

In some embodiments, the to-be-classified vector includes a to-be-classified sub-vector in a one-to-one correspondence with each to-be-classified sub-image.

As an example, it is assumed that there is a data set about a commodity, and each commodity has the following classification attributes: a commodity category, a brand, and a color. An objective is to create a to-be-classified vector that includes a to-be-classified sub-vector of each attribute. Commodity category: original information: a commodity may be electronic product, furniture, clothes, or the like. Encoding method: One-hot encoding may be used to convert each category to a vector. Electronic product: [1, 0, 0], furniture: [0, 1, 0], and clothes: [0, 0, 1]. A corresponding to-be-classified sub-vector is a three-dimensional vector. For example, a sub-vector corresponding to the electronic product is [1, 0, 0]. Brand: original information: a commodity brand may be Huawei, Apple, Xiaomi, or the like. Encoding method: One-hot encoding is also used to convert each brand to a vector. For example, Huawei: [1, 0, 0], Apple: [0, 1, 0], and Xiaomi: [0, 0, 1]. A corresponding to-be-classified sub-vector is a three-dimensional vector. For example, a sub-vector corresponding to Huawei is [1, 0, 0]. Color: original information: a commodity color may be red, blue, green, or the like. Encoding method: One-hot encoding is still used to convert each color to a vector. For example, red: [1, 0, 0], blue: [0, 1, 0], and green: [0, 0, 1]. A corresponding to-be-classified sub-vector is a three-dimensional vector. For example, a sub-vector corresponding to red is [1, 0, 0]. Finally, all the to-be-classified sub-vectors are combined, to form a to-be-classified vector. For example, for an electronic product, a to-be-classified vector of a red commodity of the Huawei brand is: [1, 0, 0, 1, 0, 0, 1, 0, 0]. The to-be-classified vector includes three to-be-classified sub-vectors: a commodity category sub-vector [1, 0, 0], a brand sub-vector [1, 0, 0], and a color sub-vector [1, 0, 0]. In this manner, non-numeric classification information may be converted to a numeric vector that can be processed by a machine learning model.

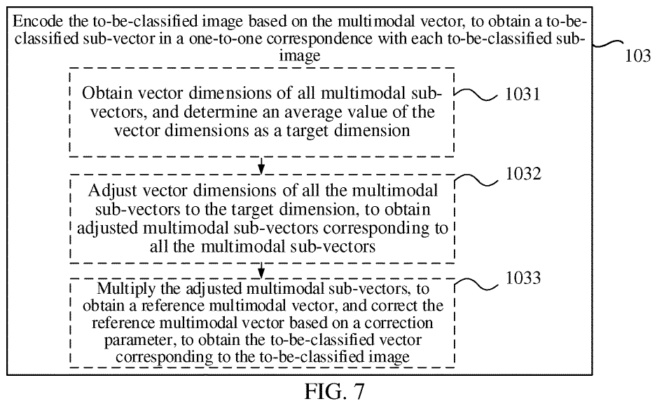

In some embodiments, the multimodal vector includes a multimodal sub-vector corresponding to each piece of modality information. FIG. 7 is a second schematic flowchart of an image classification method according to an embodiment of this application. Operation 103 shown in FIG. 4 is implemented through operation 1031 to operation 1033 in FIG. 7.

Operation 1031: Obtain vector dimensions of all multimodal sub-vectors, and determine an average value of the vector dimensions as a target dimension.

As an example, an expression of the target dimension may be:

$$W = \frac{{W}_{1} + ⋯ + {W}_{N}}{N} \qquad ( 7 )$$

where W is configured for indicating a target dimension, W₁ . . . . W_{N} is configured for indicating a vector dimension of each multimodal sub-vector, and N is configured for indicating a number of multimodal sub-vectors.

In some embodiments, the multimodal data is data of different sources or different categories, such as a text, an image, and a sound. Each source or category of data may be represented as a vector, which is referred to as a multimodal sub-vector. For example, a database for describing a commodity may include a vector of an image feature (an image sub-vector), a vector of a text description (a text sub-vector), and a vector of a sound description (a sound sub-vector). A vector dimension of each multimodal sub-vector is a number of elements in the sub-vector. For example, if an image eigenvector includes 100 features, a vector dimension thereof is 100.

Operation 1032: Adjust vector dimensions of all the multimodal sub-vectors to the target dimension, to obtain adjusted multimodal sub-vectors corresponding to all the multimodal sub-vectors.

In some embodiments, the target sub-vector and the multimodal sub-vector are in a one-to-one correspondence, and a vector dimension of the target sub-vector corresponding to the multimodal sub-vector is equal to the target dimension.

In some embodiments, the vector dimensions of the multimodal sub-vectors are respectively adjusted to the target dimension, to obtain adjusted multimodal sub-vectors respectively corresponding to the multimodal sub-vectors, thereby performing dimension averaging on the multimodal sub-vectors.

As an example, image sub-vector adjustment is as follows: an original image sub-vector is: [feature 1, feature 2, . . . , feature 512], and after a dimension reduction operation, a target image sub-vector is: [dimension reduction feature 1, dimension reduction feature 2, . . . , dimension reduction feature 312]. Text sub-vector adjustment is as follows: an original text sub-vector is: [feature 1, feature 2, . . . , feature 100], and after a dimension increasing operation, a target text sub-vector is: [original feature 1, original feature 2, . . . , original feature 100, additional feature 1, additional feature 2, . . . , additional feature 212]. In this process, each multimodal sub-vector is adjusted to a vector of a target dimension 312. The adjusted vector is referred to as a target sub-vector. For example, a target sub-vector of an image may be (only for example, not real data): [0.12, −0.03, 0.45, . . . , 0.67]. A target sub-vector of a text may be (only for example, not real data): [0.22, 0.55, 0.13, 0, 0, . . . , 0]. In this manner, it is ensured that the adjusted multimodal sub-vectors of the image and the text both have the same dimension and can be compared and fused in the same space. This processing allows features of different modalities to be effectively integrated in the same dimension, so as to better perform a multimodal task, such as multimodal classification, retrieval, or generation.

Operation 1033: Multiply the adjusted multimodal sub-vectors, to obtain a reference multimodal vector, and correct the reference multimodal vector based on a correction parameter, to obtain the to-be-classified vector corresponding to the to-be-classified image.

As an example, referring to FIG. 6, an expression of the reference multimodal vector may be:

$$O = {o}_{g} ⊗ {o}_{s} \qquad ( 8 )$$

where O is configured for indicating a reference multimodal vector, o_{g} is configured for indicating a multimodal sub-vector corresponding to the modality information 61, oₛ is configured for indicating a multimodal sub-vector corresponding to the modality information 62, and ⊗ is configured for indicating a Kronecker product.

In some embodiments, the correcting the reference multimodal vector based on a correction parameter, to obtain the to-be-classified vector corresponding to the to-be-classified image may be implemented in the following manner: obtaining a first correction parameter and a second correction parameter, and multiplying the reference multimodal vector by the first correction parameter, to obtain a intermediate to-be-classified vector corresponding to the to-be-classified image; and adding the intermediate to-be-classified vector and the second correction parameter, to obtain the to-be-classified vector corresponding to the to-be-classified image.

As an example, an expression of the to-be-classified vector corresponding to the to-be-classified image may be:

$$h = R e L u ( {W}_{fusion} * ( {o}_{g} ⊗ {o}_{s} ) + {b}_{fusion} ) \qquad ( 9 )$$

where h is configured for indicating a to-be-classified vector corresponding to a to-be-classified image, o_{g}⊗oₛ is configured for indicating a reference multimodal vector, o_{g} is configured for indicating a multimodal sub-vector corresponding to the modality information 61, oₛ is configured for indicating a multimodal sub-vector corresponding to the modality information 62, ⊗ is configured for indicating a Kronecker product, W_{fusion} is configured for indicating a first correction parameter, and b_{fusion} is configured for indicating a second correction parameter.

As an example, an objective is to fuse features in two different modalities (for example, an image and a text) into one unified feature representation, and then adjust the representation by using a correction parameter to optimize classification performance. The first correction parameter W_fusion is a weight matrix, and a dimension thereof is usually the same as a dimension of a fused eigenvector. The matrix is obtained through learning and is configured to adjust the size and direction of the fused eigenvector, to optimize the classification performance. The second correction parameter b_fusion is a bias vector, and a dimension thereof is the same as a dimension of the fused eigenvector. This vector is also obtained through learning and is configured to provide additional correction based on a weighted sum. There are eigenvectors in two modalities. One is an image eigenvector o_g, and the other is a text eigenvector o_s. An outer product operation is performed on the image eigenvector o_g and the text eigenvector o_s. This usually means multiplying the two vectors element by element, to obtain a new matrix. A dimension of this matrix is a dimension of o_g multiplied by a dimension of o_s. The matrix obtained by the outer product is multiplied by the weight matrix W_fusion, to obtain an adjusted eigenvector. The vector obtained in the previous operation is added with the bias vector b_fusion, to further adjust the eigenvector. Nonlinear transformation is performed on the adjusted eigenvector by using a rectified linear unit (ReLU) activation function, to obtain a final to-be-classified classification eigenvector h.

In this way, a unified to-be-classified classification eigenvector is generated for features in different modalities, for example, an image and a text. In this process, the reference multimodal eigenvectors are first combined by using an outer product operation, and the combined result is multiplied by the first correction parameter. In this way, not only sizes and directions of the features are adjusted, but also important associations between the features are strengthened. Subsequently, by adding the second correction parameter, the feature representation may be further optimized, so that the feature representation better meets a requirement of a classification task. Processing the result vector by using the ReLU activation function helps introduce non-linearity, so that the classification eigenvector is more diverse and distinguishable in representation. The beneficial effects of this correction and fusion policy are: improving accuracy and robustness of a classification task, so that a model can better extract and use useful information from multimodal data.

In this way, the adjusted multimodal sub-vectors are multiplied, to obtain the reference multimodal vector, and the reference multimodal vector is corrected based on the correction parameter, to obtain the to-be-classified vector corresponding to the to-be-classified image, so that the to-be-classified vector corresponding to the to-be-classified image is more accurate.

Operation 104: Classify the to-be-classified image based on the to-be-classified sub-vector corresponding to each to-be-classified sub-image, to obtain the category of the to-be-classified image.

In some embodiments, operation 104 may be implemented in the following manner: performing category prediction on each to-be-classified sub-image based on the to-be-classified sub-vector corresponding to each to-be-classified sub-image, to obtain a category prediction probability of the to-be-classified sub-image; and classifying the to-be-classified image based on the category prediction probability corresponding to each to-be-classified sub-image, to obtain the category of the to-be-classified image.

In some embodiments, the category prediction may be implemented by using a target classification model. The target classification model may be a machine learning model, and is configured to predict a category of a data sample. In a training process, the classification model learns how to map an input vector to a correct category label. The performing category prediction on each to-be-classified sub-image based on the to-be-classified sub-vector corresponding to each to-be-classified sub-image, to obtain a category prediction probability of the to-be-classified sub-image in operation 104 may be implemented in the following manner: invoking a target classification model for each to-be-classified sub-image, to perform category prediction on the to-be-classified sub-image based on the to-be-classified sub-vector corresponding to the to-be-classified sub-image, to obtain the category prediction probability of the to-be-classified sub-image.

In some embodiments, category prediction is implemented by using the target classification model, before operation 104, the target classification model may further be obtained in the following manner: obtaining a to-be-classified image sample including a plurality of to-be-classified sub-samples, and a sample label carried in the to-be-classified image sample; encoding the to-be-classified image sample, to obtain a sample vector corresponding to the to-be-classified image sample, the sample vector including a sub-sample vector in a one-to-one correspondence with each to-be-classified sub-sample; determining, for each to-be-classified sub-sample, the sample label as an initial label of the to-be-classified sub-sample, and invoking the classification model to perform category prediction on the to-be-classified sub-sample based on the sub-sample vector corresponding to the to-be-classified sub-sample, to obtain a prediction probability of the to-be-classified sub-sample; determining a target label of each to-be-classified sub-sample based on the prediction probability of the to-be-classified sub-sample; and training the classification model with reference to the prediction probability, the initial label, and the target label, to obtain a target classification model.

In some embodiments, a sample label carried in the to-be-classified image sample is configured for indicating a category to which the to-be-classified image sample belongs. The to-be-classified image sample includes a plurality of to-be-classified sub-samples. A sub-sample label carried in a to-be-classified sub-sample may be the same as a sample label carried in a corresponding to-be-classified image sample, or may be different from a sample label carried in a corresponding to-be-classified image sample. A sub-sample label carried in each to-be-classified sub-sample included in the to-be-classified image sample is associated with the sample label carried in the to-be-classified image sample. That is, the sub-sample label carried in each to-be-classified sub-sample included in the to-be-classified image sample affects the sample label carried in the to-be-classified image sample.

In some embodiments, the sample vector includes a sub-sample vector in a one-to-one correspondence with a to-be-classified sub-sample, and the sample vector corresponding to the to-be-classified image sample is configured for indicating an attribute or a feature of the to-be-classified image sample.

In some embodiments, the encoding the to-be-classified image sample, to obtain a sample vector corresponding to the to-be-classified image sample may be implemented in the following manner: converting the to-be-classified image sample between different modalities, to obtain a modality sample of the to-be-classified image sample that corresponds to each modality; performing modality fusion on all modality samples, to obtain a multimodal sample vector corresponding to the to-be-classified image sample; and encoding the to-be-classified image sample based on the multimodal sample vector, to obtain the sample vector corresponding to the to-be-classified image sample.

In some embodiments, the multimodal sample vector includes a multimodal sample sub-vector corresponding to each modality sample, and the performing modality fusion on all modality samples, to obtain a multimodal sample vector corresponding to the to-be-classified image sample may be implemented in the following manner: encoding each modality sample, to obtain a modality sample vector corresponding to the modality sample; and performing the following processing on each modality sample: determining the modality sample as a target modality sample, and determining each modality sample other than the target modality sample as a reference modality sample; performing vector conversion on a modality sample vector corresponding to the target modality sample, to obtain a target modality sample vector corresponding to the target modality sample; performing vector fusion on the modality sample vector corresponding to the target modality sample and a modality sample vector corresponding to each reference modality sample, to obtain a fused modality sample vector corresponding to the target modality sample; and performing vector fusion on the fused modality sample vector and the target modality sample vector, to obtain a multimodal sample sub-vector corresponding to the target modality sample.

In some embodiments, the performing vector conversion on a modality sample vector corresponding to the target modality sample, to obtain a target modality sample vector corresponding to the target modality sample may be implemented in the following manner: obtaining a target conversion vector corresponding to the target modality sample and a target correction vector corresponding to the target modality sample, where a vector dimension of the modality sample vector corresponding to the target modality sample is the same as both vector dimensions of the corresponding target conversion vector and the corresponding target correction vector; multiplying the modality sample vector corresponding to the target modality sample and the target conversion vector, to obtain a converted modal vector corresponding to the target modality sample; adding the target conversion vector and the target correction vector, to obtain an intermediate target modal vector corresponding to the target modality sample; and performing vector activation on the target correction vector, to obtain the target modality sample vector corresponding to the target modality sample.

In some embodiments, the performing vector fusion on the modality sample vector corresponding to the target modality sample and a modality sample vector corresponding to each reference modality sample, to obtain a fused modality sample vector corresponding to the target modality sample may be implemented in the following manner: obtaining a reference conversion vector corresponding to the target modality sample and a reference correction vector corresponding to the target modality sample, where a vector dimension of the modality sample vector corresponding to the target modality sample is the same as both vector dimensions of the corresponding reference conversion vector and the corresponding reference correction vector; performing vector transposition on the modality sample vector corresponding to the target modality sample, to obtain a transposed target modal vector corresponding to the target modality sample; multiplying the transposed target modal vector by the corresponding reference conversion vector, to obtain a first reference vector, and multiplying the first reference vector by the modality sample vector, to obtain a second reference vector; and adding the reference correction vector corresponding to the target modality sample and the second reference vector, to obtain the fused modality sample vector corresponding to the target modality sample.

In some embodiments, the multimodal sample vector includes a multimodal sample sub-vector corresponding to each modality sample, and the encoding the to-be-classified image sample based on the multimodal sample vector, to obtain a sample vector corresponding to the to-be-classified image sample may be implemented in the following manner: obtaining vector dimensions of all multimodal sample sub-vectors, and determining an average value of the vector dimensions as a target dimension; adjusting vector dimensions of all the multimodal sample sub-vectors to the target dimension, to obtain adjusted multimodal sub-vectors corresponding to all the multimodal sample sub-vectors; and multiplying the adjusted multimodal sub-vectors, to obtain a reference multimodal vector, and correcting the reference multimodal vector based on a correction parameter, to obtain the sample vector corresponding to the to-be-classified image sample.

As an example, a to-be-classified image sample A includes a to-be-classified sub-sample A1, a to-be-classified sub-sample A2, and a to-be-classified sub-sample A3. A sample label carried in the to-be-classified image sample A is a category T, and the sample label carried in the to-be-classified image sample A, that is, the category T, is determined as initial labels of the to-be-classified sub-sample A1, the to-be-classified sub-sample A2, and the to-be-classified sub-sample A3.

In some embodiments, the classification model may be a convolutional neural network, and the convolutional neural network is a type of feed forward neural network (FNN) that includes convolutional computation and has a deep structure, and is one of representative algorithms of deep learning. The convolutional neural network has a representation learning capability, and can perform shift-invariant classification on an input image according to a hierarchical structure thereof.

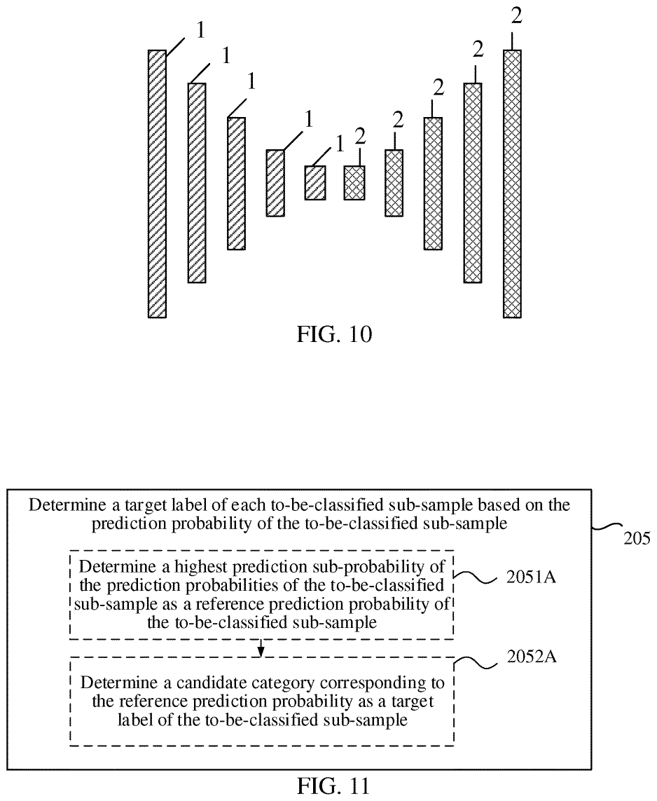

As an example, FIG. 10 is a schematic structural diagram of a classification model according to an embodiment of this application. The classification model includes an encoding layer 1 and a decoding layer 2. The encoding layer 1 is invoked to perform sample encoding on each to-be-classified sub-sample based on a sub-sample vector corresponding to the to-be-classified sub-sample, to obtain a target sub-sample vector. The decoding layer 2 is invoked to perform category prediction on the to-be-classified sub-sample based on the target sub-sample vector, to obtain a prediction probability of the to-be-classified sub-sample.

In some embodiments, the prediction probability includes a prediction sub-probability in a one-to-one correspondence with each candidate category.

As an example, an expression of the prediction probability may be:

$$P = \{ {P}_{1} , … , {P}_{n} \} \qquad ( 10 )$$

where P is configured for indicating a prediction probability, P₁, . . . , Pₙ is configured for indicating a prediction sub-probability in a one-to-one correspondence with each candidate category, and n is configured for indicating a number of candidate categories.

In some embodiments, the target label of the to-be-classified sub-sample is configured for indicating a candidate category to which the to-be-classified sub-sample belongs.

In some embodiments, the category prediction probability includes a category probability in a one-to-one correspondence with each candidate category, and the category probability is configured for indicating a probability that the to-be-classified sub-image belongs to a corresponding candidate category.

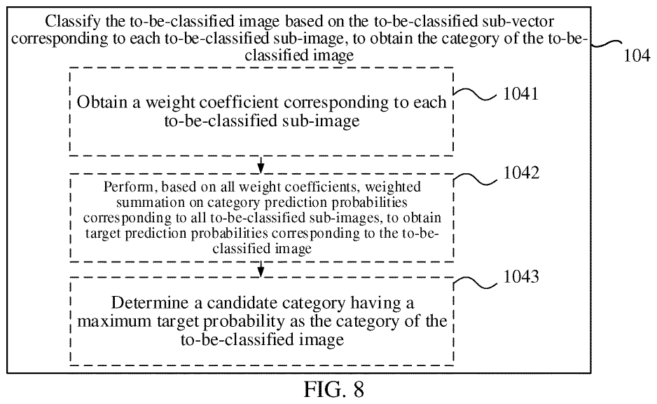

In some embodiments, FIG. 8 is a fourth schematic flowchart of an image classification method according to an embodiment of this application. Operation 104 of classifying the to-be-classified image based on the category prediction probability corresponding to each to-be-classified sub-image, to obtain the category of the to-be-classified image shown in FIG. 4 may be implemented through operation 1041 to operation 1043 shown in FIG. 8.

Operation 1041: Obtain a weight coefficient corresponding to each to-be-classified sub-image.

In some embodiments, the to-be-classified sub-image is in a one-to-one correspondence with the weight coefficient, and the weight coefficient is configured for indicating importance of the to-be-classified sub-image in the to-be-classified image.

As an example, to-be-classified sub-images include a to-be-classified sub-image A and a to-be-classified sub-image B, a weight coefficient corresponding to the to-be-classified sub-image A is A1, and a weight coefficient corresponding to the to-be-classified sub-image B is A2.

In some embodiments, the weight coefficient is a common parameter in a machine learning model, and is configuring for quantifying a degree of contribution of an input feature (which is a to-be-classified sub-image in this example) to an output of the model. Each to-be-classified sub-image corresponds to a unique weight coefficient, configured for indicating importance of this sub-information in the overall to-be-classified image. A value of the weight coefficient reflects a degree of impact of the to-be-classified sub-image on a classification result. A high weight coefficient indicates that this sub-information is very important in a classification decision, and a low weight coefficient indicates that this sub-information has little impact on a classification result.

As an example, the to-be-classified sub-image A is one piece of sub-information in a classification task, for example, may represent a particular attribute of a product. The to-be-classified sub-image B is sub-information in another classification task and is different from the to-be-classified sub-image A, and may represent another attribute of the product. The weight coefficient A1 is a weight coefficient in a one-to-one correspondence with the to-be-classified sub-image A, and is configured for indicating importance of the to-be-classified sub-image A in the to-be-classified image. The weight coefficient A2 is a weight coefficient in a one-to-one correspondence with the to-be-classified sub-image B, and is configured for indicating importance of the to-be-classified sub-image B in the to-be-classified image.

Operation 1042: Perform, based on all weight coefficients, weighted summation on category prediction probabilities corresponding to all to-be-classified sub-images, to obtain target prediction probabilities corresponding to the to-be-classified image.

In some embodiments, the target prediction probabilities include a target probability in a one-to-one correspondence with each candidate category.

As an example, an expression of the target prediction probabilities corresponding to the to-be-classified image may be:

$${p}_{i} = sum ( {p}_{i}^{j} * f r {e}_{i}^{j} ) \qquad ( 11 )$$

where pᵢ is configured for indicating a target prediction probability corresponding to a to-be-classified image,

$${p}_{i}^{j}$$

is configured for indicating a category prediction probability corresponding to each to-be-classified sub-image, and

$$f r {e}_{i}^{j}$$

is configured for indicating a weight coefficient corresponding to each to-be-classified sub-image.

Operation 1043: Determine a candidate category having a highest target probability as the category of the to-be-classified image.

As an example, a target probability corresponding to a candidate category A is 0.5, a target probability corresponding to a candidate category B is 0.6, and a target probability corresponding to a candidate category C is 0.1. In this case, the candidate category B having the highest target probability is determined as a category of the to-be-classified image.

In this way, introduction of the weight coefficient can highlight importance of different sub-information in classification, thereby prioritizing key information during comprehensive prediction and reducing interference of noise information. In addition, the target prediction probability obtained after weighted summation better conforms to an actual case because importance and probability distribution of each piece of sub-information are comprehensively considered. Finally, by comparing target prediction probabilities, a candidate category having a highest probability is determined as the category of the to-be-classified image, so that reliability of a classification result can be ensured, and accuracy and robustness of overall classification can be improved. This has significant advantages in multi-attribute decision-making and complex information processing, which helps optimize the performance and efficiency of information classification.

In this way, the to-be-classified image is converted between different modalities including a plurality of to-be-classified sub-images, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image; category prediction is performed on each to-be-classified sub-image based on the to-be-classified sub-vector corresponding to each to-be-classified sub-image, to obtain a category prediction probability of the to-be-classified sub-image; and the to-be-classified image is classified based on the category prediction probability corresponding to each to-be-classified sub-image, to obtain the category of the to-be-classified image. In this way, modality fusion is performed on modality information obtained by converting the to-be-classified image between different modalities, so that the obtained multimodal vector can accurately reflect modality features of the to-be-classified image from different modalities. In addition, the to-be-classified image is encoded based on the multimodal vector, to obtain the to-be-classified vector, thereby effectively increasing an information amount of the to-be-classified vector. Besides, category prediction is performed on each to-be-classified sub-image based on the to-be-classified vector corresponding to the to-be-classified sub-image. Because the to-be-classified vector on which category prediction is based has a more comprehensive information amount, a category prediction probability obtained through prediction is more accurate. The to-be-classified image is classified based on the accurate category prediction probability, thereby effectively improving information classification accuracy.

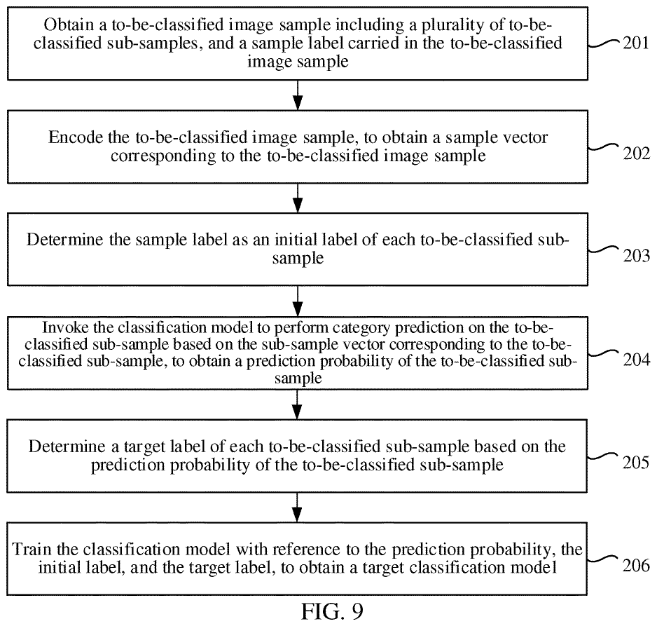

FIG. 9 is a first schematic flowchart of an image classification model training method according to an embodiment of this application. The method is described with reference to operation 201 to operation 206 shown in FIG. 9. The image classification model training method provided in the embodiments of this application may be implemented by a server or a terminal alone, or may be cooperatively implemented by a server and a terminal. The following describes an example in which the method is implemented by a server alone.

Operation 201: Obtain a to-be-classified image sample including a plurality of to-be-classified sub-samples, and a sample label carried in the to-be-classified image sample.

In some embodiments, a sample label carried in the to-be-classified image sample is configured for indicating a category to which the to-be-classified image sample belongs. The to-be-classified image sample includes a plurality of to-be-classified sub-samples. A sub-sample label carried in a to-be-classified sub-sample may be the same as a sample label carried in a corresponding to-be-classified image sample, or may be different from a sample label carried in a corresponding to-be-classified image sample. A sub-sample label carried in each to-be-classified sub-sample included in the to-be-classified image sample is associated with the sample label carried in the to-be-classified image sample. That is, the sub-sample label carried in each to-be-classified sub-sample included in the to-be-classified image sample affects the sample label carried in the to-be-classified image sample.

Operation 202: Encode the to-be-classified image sample, to obtain a sample vector corresponding to the to-be-classified image sample.

In some embodiments, the sample vector includes a sub-sample vector in a one-to-one correspondence with a to-be-classified sub-sample, and the sample vector corresponding to the to-be-classified image sample is configured for indicating an attribute or a feature of the to-be-classified image sample.

In some embodiments, the encoding the to-be-classified image sample, to obtain a sample vector corresponding to the to-be-classified image sample may be implemented in the following manner: converting the to-be-classified image sample between different modalities, to obtain a modality sample of the to-be-classified image sample that corresponds to each modality; performing modality fusion on all modality samples, to obtain a multimodal sample vector corresponding to the to-be-classified image sample; and encoding the to-be-classified image sample based on the multimodal sample vector, to obtain the sample vector corresponding to the to-be-classified image sample.

In some embodiments, the to-be-classified image sample includes a plurality of to-be-classified sub-images, and the to-be-classified sub-images are composition elements of the to-be-classified image sample. For example, a to-be-classified image sample A includes a to-be-classified sub-image A1, a to-be-classified sub-image A2, and a to-be-classified sub-image A3.

In some embodiments, the modality is used for indicating an information perceptual channel, and information perceptual channels corresponding to different modality information are different. For example, an information perceptual channel corresponding to video modality information in a video modality is a video, and an information perceptual channel corresponding to audio modality information in an audio modality is an audio. The modality conversion is a processing process of converting the to-be-classified image sample in an original modality to modality information in a target modality.

In some embodiments, the converting the to-be-classified image sample between different modalities, to obtain modality information of the to-be-classified image sample that corresponds to each modality may be implemented in the following manner: when the to-be-classified image sample is multimodality information, obtaining each target modality of the to-be-classified image sample, and extracting, for each target modality, modality information in the target modality from the to-be-classified image sample, to obtain modality information of the to-be-classified image sample that corresponds to the target modality; or when the to-be-classified image sample is single-modality information, obtaining a plurality of target modalities, and for each target modality, converting the to-be-classified image sample to the target modality, to obtain modality information of the to-be-classified image sample that corresponds to the target modality.

As an example, in an application scenario of text classification, a to-be-classified image sample may be obtained by converting a to-be-classified text (single-modality information). The to-be-classified text includes a plurality of to-be-classified subtexts. For example, the to-be-classified text is “tumor exists in the liver area”, and the plurality of to-be-classified subtexts included in the to-be-classified text may be “liver area”, “exists”, and “tumor”. The to-be-classified image sample is converted to an audio modality, to obtain a to-be-classified audio in the audio modality corresponding to the to-be-classified image sample; and the to-be-classified image sample is converted to a text modality, to obtain a to-be-classified text in the text modality corresponding to the to-be-classified image sample.

As an example, in an application scenario of medical information classification, the to-be-classified image sample may be an image including a to-be-classified immune receptor repertoire. The to-be-classified immune receptor repertoire includes a plurality of immune receptors, and an area of an immune receptor in the to-be-classified image sample is a to-be-classified sub-image in the to-be-classified image sample. The to-be-classified immune receptor repertoire is converted to an amino acid sequence modality, to obtain an amino acid sequence of the to-be-classified immune receptor repertoire in an amino acid sequence modality. The to-be-classified immune receptor repertoire is converted to a gene segment modality, to obtain gene segments of the to-be-classified immune receptor repertoire in the gene segment modality.

In some embodiments, the multimodal sample vector includes a multimodal sample sub-vector corresponding to each modality sample, and the performing modality fusion on all modality samples, to obtain a multimodal sample vector corresponding to the to-be-classified image sample may be implemented in the following manner: encoding each modality sample, to obtain a modality sample vector corresponding to the modality sample; and performing the following processing on each modality sample: determining the modality sample as a target modality sample, and determining each modality sample other than the target modality sample as a reference modality sample; performing vector conversion on a modality sample vector corresponding to the target modality sample, to obtain a target modality sample vector corresponding to the target modality sample; performing vector fusion on the modality sample vector corresponding to the target modality sample and a modality sample vector corresponding to each reference modality sample, to obtain a fused modality sample vector corresponding to the target modality sample; and performing vector fusion on the fused modality sample vector and the target modality sample vector, to obtain a multimodal sample sub-vector corresponding to the target modality sample.

In some embodiments, the modality fusion refers to a process of integrating information in different modalities (for example, text, image, and audio) in a multimodal data processing system. Each modality usually includes a different aspect or feature of data, and the objective of modality fusion is to combine these different information sources, to obtain a more comprehensive and diverse data representation.

In this way, a sample in each modality is processed as the target modality sample, and a sample in another modality is processed as the reference modality sample. This method can ensure that the sample in each modality can be processed, and personalized vector conversion can be performed based on features of the sample in each modality, thereby improving correlation and complementation between modalities. Vector conversion on the vector in the target modality sample not only can highlight features of the target modality sample, and the conversion can enhance fusion with a sample in another modality. Vector fusion is performed on the vector of the target modality sample and the vector of each reference modality sample, to obtain a fused modality sample vector in which information in a plurality of modalities is fused. This operation helps to integrate information in different modalities, thereby improving comprehensiveness and accuracy of feature representation. Vector fusion is performed again on the fused modality sample vector and the target modality sample vector, to obtain the multimodal sample sub-vector, so that original information of the target modality sample and additional information obtained through fusion are further integrated. This multimodal sample sub-vector not only includes diverse feature information, but also provides more accurate and robust data basis for subsequent classification, recognition, or other advanced tasks, thereby helping improve performance of the entire multimodal processing system.

In some embodiments, the performing vector conversion on a modality sample vector corresponding to the target modality sample, to obtain a target modality sample vector corresponding to the target modality sample may be implemented in the following manner: obtaining a target conversion vector corresponding to the target modality sample and a target correction vector corresponding to the target modality sample, where a vector dimension of the modality sample vector corresponding to the target modality sample is the same as both vector dimensions of the corresponding target conversion vector and the corresponding target correction vector; multiplying the modality sample vector corresponding to the target modality sample and the target conversion vector, to obtain a converted modal vector corresponding to the target modality sample; adding the target conversion vector and the target correction vector, to obtain an intermediate target modal vector corresponding to the target modality sample; and performing vector activation on the target correction vector, to obtain the target modality sample vector corresponding to the target modality sample.

In some embodiments, vector activation refers to a process of applying a nonlinear function to a vector in machine learning and deep learning, and aims to increase a nonlinear capability of a model, thereby improving an approximation capability of the model to a complex function. In a scenario described in the context, vector activation refers to obtaining a target conversion vector and a target correction vector that correspond to target modality information and then performing nonlinear transformation on the vectors, to obtain a final target modal vector.

In this way, in a multimodal data processing and conversion task, the target conversion vector and the target correction vector corresponding to the target modality sample are obtained, and dimensions of these vectors are the same as the dimension of the modality sample vector. This has the following beneficial effects: First, the converted modal vector is obtained by multiplying the modality sample vector by the target conversion vector, so that an original modality can be effectively mapped to a target modality space. This helps implement effective conversion between modalities and feature preserving. In addition, the target conversion vector and the target correction vector are added, to form the intermediate target modal vector, and further, the mapping result is fine-tuned, helping improve accuracy and vividness of the converted target modality sample. Finally, vector activation is performed on the intermediate target modal vector, to activate a dimension having a prominent feature in the target modality sample vector, thereby generating a sample vector more conforming to feature distribution in the target modality. These series of processing not only improve the efficiency and accuracy of modality conversion, but also enhance a model generalization capability, so that the model can better adapt to a complex conversion relationship between different modalities, and provide strong support for fusion, analysis, and application of multimodal data.

In some embodiments, the performing vector fusion on the modality sample vector corresponding to the target modality sample and a modality sample vector corresponding to each reference modality sample, to obtain a fused modality sample vector corresponding to the target modality sample may be implemented in the following manner: obtaining a reference conversion vector corresponding to the target modality sample and a reference correction vector corresponding to the target modality sample, where a vector dimension of the modality sample vector corresponding to the target modality sample is the same as both vector dimensions of the corresponding reference conversion vector and the corresponding reference correction vector; performing vector transposition on the modality sample vector corresponding to the target modality sample, to obtain a transposed target modal vector corresponding to the target modality sample; multiplying the transposed target modal vector by the corresponding reference conversion vector, to obtain a first reference vector, and multiplying the first reference vector by the modality sample vector, to obtain a second reference vector; and adding the reference correction vector corresponding to the target modality sample and the second reference vector, to obtain the fused modality sample vector corresponding to the target modality sample.

As an example, it is assumed that data in two modalities, that is, an image and a text is being processed, and it is hoped to convert the image modality to the text modality, to facilitate cross-modality retrieval or analysis. In this process, first, a reference conversion vector and one reference correction vector corresponding to the target modality sample are obtained. For example, if the target modality is text, the reference conversion vector may include some text features, such as a word frequency, a TF-IDF score, or an embedding representation. This vector is configured to convert an image feature to a text feature. The reference correction vector includes some slightly adjusted parameters, to further optimize text features after conversion. Herein, it is assumed that there is an image modality sample vector that includes features such as a color, a shape, and a texture of an image, and a dimension of the vector is the same as dimensions of the reference conversion vector and the reference correction vector. A subsequent operation is as follows: performing vector transposition on the image modality sample vector, to obtain a transposed target modal vector. This operation is equivalent to changing a row of image features into a column, which may help a subsequent matrix multiplication operation. Then, the transposed target modal vector is multiplied by the reference conversion vector, to obtain a first reference vector. This operation may be considered as a manner of mapping an image feature into a text feature space. Next, the first reference vector is multiplied by an original modality sample vector (an image eigenvector that has not been transposed), to obtain a second reference vector. This refines a mapping process, so that the converted text feature better conforms to semantic content of the original image. Finally, the reference correction vector of the target modality sample and the second reference vector are added, to obtain the fused modality sample vector. This fused vector is a final output. The fused vector not only includes the feature information of the original image, but also integrates the converted text feature. In addition, the fused vector is adjusted by the reference correction vector to be closer to an expected target text modality feature. Through this process, a sample in an image modality can be converted to a sample in a text modality. This conversion is very useful for implementing information fusion between an image and a text and a cross-modality retrieval task.

In this way, original information of the target modality sample vector and conversion information provided in reference conversion are effectively combined through vector transposition and multiplication operations. This not only enhances an expression capability of a sample feature, but also helps to disclose correlation between different modalities. The transposed target modal vector is multiplied by the reference conversion vector to obtain the first reference vector, and the first reference vector is multiplied by the modality sample vector to obtain the second reference vector, so that a deeper feature representation can be extracted, respectively corresponding to feature conversion and re-expression, and facilitating wanted signal identification and noise suppression. The reference correction vector and the second reference vector are added, to obtain the fused modality sample vector, and the correction information and the converted feature information are combined, so that the fused modality sample vector retains an original feature, and facilitates understanding and representation of a feature of the target modality sample, thereby improving the accuracy and efficiency of modality fusion.

In some embodiments, the multimodal sample vector includes a multimodal sample sub-vector corresponding to each modality sample, and the encoding the to-be-classified image sample based on the multimodal sample vector, to obtain a sample vector corresponding to the to-be-classified image sample may be implemented in the following manner: obtaining vector dimensions of all multimodal sample sub-vectors, and determining an average value of the vector dimensions as a target dimension; adjusting vector dimensions of all the multimodal sample sub-vectors to the target dimension, to obtain adjusted multimodal sub-vectors corresponding to all the multimodal sample sub-vectors; and multiplying the adjusted multimodal sub-vectors, to obtain a reference multimodal vector, and correcting the reference multimodal vector based on a correction parameter, to obtain the sample vector corresponding to the to-be-classified image sample.

As an example, there is a group of multimodal sub-sample vectors, and these vectors respectively come from different modalities, for example, an image eigenvector and an audio eigenvector. Dimensions of the vectors may be different. The image eigenvector may have thousands of dimensions, and the audio eigenvector may have hundreds of dimensions. Vector dimensions of the multimodal sub-sample vectors are obtained. For example, a dimension of an image eigenvector may be 1024, and a dimension of an audio eigenvector may be 128. An average value of the vector dimensions is calculated, and is determined as the target dimension: If there are five multimodal sub-sample vectors and dimensions are respectively 1024, 128, 256, 512, and 768, an average dimension (the target dimension) thereof is (1024+128+256+512+768)/5=512. Vector dimensions of the multimodal sub-sample vectors are respectively adjusted to the target dimension: each vector needs to be adjusted to the dimension 512. This may be implemented by means of interpolation, dimension reduction, or learning a mapping function. The adjusted vector is referred to as a target sub-vector. The adjusted multimodal sub-vectors are multiplied. For example, the adjusted image target sub-vector is multiplied by the adjusted audio target sub-vector, to obtain a single reference multimodal vector. The “multiplication” herein may refer to element-level multiplication, or may refer to matrix multiplication, which depends on a specific data processing manner. The reference multimodal vector is corrected based on the correction parameter. The reference multimodal vector may further need to be corrected, to better adapt to a requirement of a classification task. The correction parameter may be obtained through training data learning and may be used to adjust a value of the reference multimodal vector, to enhance some features or suppress noise. A finally obtained vector is referred to as the sample vector corresponding to the to-be-classified image sample. Through this process, features from different modalities can be fused into a single vector. The vector includes information in a plurality of modalities, and is adjusted and corrected to adapt to a requirement of a classification task. This fused multimodal vector can represent an original sample more comprehensively, thereby achieving better performance in a classification task.

In this way, consistency in dimensions of the multimodal sub-sample vectors can be ensured, and a standardized basis is provided for a subsequent vector operation. Specifically, the dimension of each sub-sample vector is adjusted to the target dimension, to obtain each corresponding target sub-vector, thereby not only simplifying a processing process of multimodal data, but also improving data processing accuracy. The adjusted multimodal sub-vectors are multiplied, to integrate into a reference multimodal vector. This vector integrates information in different modalities, thereby enhancing a sample feature representation capability. This operation helps to mine internal connections between different modalities, and provides more comprehensive and in-depth information for a subsequent classification task. Correction of the reference multimodal vector based on the correction parameter can further optimize the sample vector, to better adapt to a requirement of a classification task. The corrected sample vector retains original information, and improves classification accuracy and robustness. The process from dimension analysis to vector adjustment and then to correction not only optimizes a multimodal data processing procedure, but also effectively improves performance of a sample vector in a classification task, and provides strong support for a final classification result.

Operation 203: Determine the sample label as an initial label of each to-be-classified sub-sample.

As an example, a to-be-classified image sample A includes a to-be-classified sub-sample A1, a to-be-classified sub-sample A2, and a to-be-classified sub-sample A3. A sample label carried in the to-be-classified image sample A is a category T, and the sample label carried in the to-be-classified image sample A, that is, the category T, is determined as initial labels of the to-be-classified sub-sample A1, the to-be-classified sub-sample A2, and the to-be-classified sub-sample A3.

Operation 204: Invoke the classification model to perform category prediction on the to-be-classified sub-sample based on the sub-sample vector corresponding to the to-be-classified sub-sample, to obtain a prediction probability of the to-be-classified sub-sample.

In some embodiments, the classification model may be a convolutional neural network, and the convolutional neural network is a type of feed forward neural network (FNN) that includes convolutional computation and has a deep structure, and is one of representative algorithms of deep learning. The convolutional neural network has a representation learning capability, and can perform shift-invariant classification on an input image according to a hierarchical structure thereof.

As an example, FIG. 10 is a schematic structural diagram of a classification model according to an embodiment of this application. The classification model includes an encoding layer 1 and a decoding layer 2. Operation 204 can be implemented in the following manner: invoking the encoding layer 1 to perform sample encoding on each to-be-classified sub-sample based on a sub-sample vector corresponding to the to-be-classified sub-sample, to obtain a target sub-sample vector; and invoking the decoding layer 2 to perform category prediction on the to-be-classified sub-sample based on the target sub-sample vector, to obtain a prediction probability of the to-be-classified sub-sample.

Operation 205: Determine a target label of each to-be-classified sub-sample based on the prediction probability of the to-be-classified sub-sample.

In some embodiments, the prediction probability includes a prediction sub-probability in a one-to-one correspondence with each candidate category.

As an example, an expression of the prediction probability may be:

$$P = \{ {P}_{1} , … , {P}_{n} \} \qquad ( 12 )$$

where P is configured for indicating a prediction probability, P₁, . . . , Pₙ is configured for indicating a prediction sub-probability in a one-to-one correspondence with each candidate category, and n is configured for indicating a number of candidate categories.

In some embodiments, the target label of the to-be-classified sub-sample is configured for indicating a candidate category to which the to-be-classified sub-sample belongs.

In some embodiments, FIG. 11 is a second schematic flowchart of an image classification model training method according to an embodiment of this application. Operation 205 shown in FIG. 9 may be implemented by performing operation 2051A and operation 2052A shown in FIG. 11 on each to-be-classified sub-sample.

Operation 2051A: Determine a highest prediction sub-probability of the prediction probabilities of the to-be-classified sub-sample as a reference prediction probability of the to-be-classified sub-sample.

In the above example, when n is equal to 3, a prediction sub-probability corresponding to the candidate category A1 is 0.2, a prediction sub-probability corresponding to the candidate category A2 is 0.3, and a prediction sub-probability corresponding to the candidate category A3 is 0.5. In this case, the largest prediction sub-probability 0.5 of the prediction probabilities of the to-be-classified sub-sample is determined as the reference prediction probability of the to-be-classified sub-sample.

Operation 2052A: Determine the candidate category corresponding to the reference prediction probability as the target label of the to-be-classified sub-sample.

In the above example, the candidate category A3 corresponding to the reference prediction probability is determined as the target label of the to-be-classified sub-sample.

In this way, the highest prediction sub-probability of the prediction probabilities of the to-be-classified sub-sample is determined as the reference prediction probability of the to-be-classified sub-sample, and the candidate category corresponding to the reference prediction probability is determined as the target label of the to-be-classified sub-sample, so that the candidate category corresponding to the highest prediction sub-probability is selected from a plurality of existing candidate categories as the target label of the to-be-classified sub-sample, thereby effectively improving accuracy of the target label.

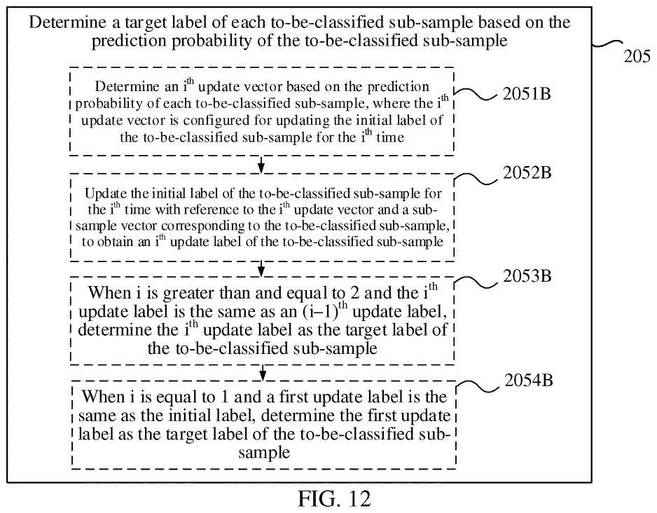

In some embodiments, FIG. 12 is a third schematic flowchart of an image classification model training method according to an embodiment of this application. Operation 205 shown in FIG. 9 may be implemented by performing operation 2051B to operation 2054B shown in FIG. 12 on each to-be-classified sub-sample by traversing i, until the target label of the to-be-classified sub-sample is obtained.

Operation 2051B: Determine an i^{th} update vector based on the prediction probability of each to-be-classified sub-sample, where the i^{th} update vector is configured for updating the initial label of the to-be-classified sub-sample for the i^{th} time.

In some embodiments, 1≤i≤N, and N is configured for indicating a maximum number of times of updating the initial label of the to-be-classified sub-sample.

In some embodiments, operation 2051B may be implemented in the following manner: when i is equal to 1, determining a first update vector based on the prediction probability of each to-be-classified sub-sample; or when i is greater than or equal to 2, performing vector update on the first update vector for an (i−1)^{th} time based on the sub-sample vector corresponding to the to-be-classified sub-sample, to obtain the i^{th} update vector.

As an example, when i is equal to 1, the first update vector is determined based on the prediction probability of each to-be-classified sub-sample; or when i is equal to 2, vector update is performed on the first update vector for the first time based on the sub-sample vector corresponding to the to-be-classified sub-sample, to obtain a second update vector; when i is equal to 3, vector update is performed on the first update vector for the second time based on the sub-sample vector corresponding to the to-be-classified sub-sample, to obtain a third update vector; and when i is equal to 4, vector update is performed on the first update vector for the third time based on the sub-sample vector corresponding to the to-be-classified sub-sample, to obtain a fourth update vector.

In some embodiments, the prediction probability includes a prediction sub-probability in a one-to-one correspondence with each candidate category, and the determining a first update vector based on the prediction probability of each to-be-classified sub-sample may be implemented in the following manner: for each candidate category, selecting, from the plurality of to-be-classified sub-samples based on the prediction probability of each to-be-classified sub-sample, a target sub-sample corresponding to the candidate category, and determining, based on a sub-sample vector corresponding to the target sub-sample, a category update vector corresponding to the candidate category; and performing vector fusion on category update vectors, to obtain the first update vector.

As an example, an expression of the first update vector may be:

$${T}_{1} = \{ {T}_{11} , … , {T}_{1 m} \} \qquad ( 13 )$$

where T₁ is configured for indicating the first update vector, T₁₁, . . . , T₁ₘ is configured for indicating a category update vector corresponding to a candidate category, and m is configured for indicating a number of candidate categories.

In some embodiments, a prediction sub-probability that is of the prediction probabilities of the target sub-sample and that corresponds to the candidate category is greater than a probability threshold.

In some embodiments, the selecting, from the plurality of to-be-classified sub-samples based on the prediction probability of each to-be-classified sub-sample, a target sub-sample corresponding to the candidate category may be implemented in the following manner: performing the following processing on each to-be-classified sub-sample: determining, as a target sub-probability that is of the to-be-classified sub-sample and that corresponds to the candidate category, a prediction sub-probability that is of prediction probabilities of the to-be-classified sub-sample and that corresponds to the candidate category; and when the target sub-probability is greater than the probability threshold, determining the to-be-classified sub-sample as the target sub-sample corresponding to the candidate category.

As an example, for a candidate category B1, the prediction probability of the to-be-classified sub-sample includes a prediction probability corresponding to each candidate category, a prediction sub-probability that is of prediction probabilities of the to-be-classified sub-sample and that corresponds to the candidate category B1 is determined as a target sub-probability that is of the to-be-classified sub-sample and that corresponds to the candidate category B1; and when the target sub-probability is greater than the probability threshold, the to-be-classified sub-sample is determined as the target sub-sample corresponding to the candidate category.

As an example, for a candidate category B2, the prediction probability of the to-be-classified sub-sample includes a prediction probability corresponding to each candidate category, a prediction sub-probability that is of prediction probabilities of the to-be-classified sub-sample and that corresponds to the candidate category B2 is determined as a target sub-probability that is of the to-be-classified sub-sample and that corresponds to the candidate category B2; and when the target sub-probability is greater than the probability threshold, the to-be-classified sub-sample is determined as the target sub-sample corresponding to the candidate category.

In some embodiments, the determining, based on a sub-sample vector corresponding to the target sub-sample, a category update vector corresponding to the candidate category may be implemented in the following manner: when there is one target sub-sample, determining the sub-sample vector corresponding to the target sub-sample as the category update vector corresponding to the candidate category; or when there is a plurality of target sub-samples, performing vector fusion on sub-sample vectors respectively corresponding to the target sub-samples, to obtain the category update vector corresponding to the candidate category.

In some embodiments, for each candidate category, when the candidate category corresponds to one target sub-sample, a sub-sample vector corresponding to the target sub-sample corresponding to the candidate category is determined as the category update vector corresponding to the candidate category; or when the candidate category corresponds to a plurality of target sub-samples, vector fusion is performed on sub-sample vectors respectively corresponding to the target sub-samples corresponding to the candidate category, to obtain the category update vector corresponding to the candidate category.

As an example, when the candidate category corresponds to a plurality of target sub-samples, an expression of the category update vector corresponding to the candidate category may be:

$${Q}_{1} = \{ {Q}_{11} , … , {Q}_{1 T} \} \qquad ( 14 )$$

where Q₁ is configured for indicating a category update vector corresponding to a candidate category, Q₁₁, . . . , Q_{1T} is configured for indicating a sub-sample vector corresponding to each target sub-sample corresponding to the candidate category, and T is configured for indicating a number of target sub-samples corresponding to the candidate category.

In some embodiments, the performing vector update on the first update vector for an (i−1)^{th} time based on the sub-sample vector corresponding to the to-be-classified sub-sample, to obtain the i^{th} update vector may be implemented in the following manner: when i is equal to 2, performing weighted fusion on the first update vector and the sub-sample vector corresponding to the to-be-classified sub-sample, to obtain a second update vector; or when i is greater than or equal to 2, performing weighted fusion on the (i−1)^{th} update vector and the sub-sample vector corresponding to the to-be-classified sub-sample, to obtain the i^{th} update vector.

As an example, an expression of the i^{th} update vector may be:

$${E}_{prototype}^{c , e + 1} = Normalize ( λ * {E}_{prototype}^{c , e} + ( 1 - λ ) * {h}_{i}^{k , e , c} ) \qquad ( 15 )$$

where

$${E}_{prototype}^{c , e + 1}$$

is configured for indicating an i^{th} update vector,

$${E}_{p r o t o t y p e}^{c , e}$$

is configured for indicating an (i−1)^{th} update vector, and

$${h}_{i}^{k , e , c}$$

is configured for indicating a sub-sample vector corresponding to a to-be-classified sub-sample.

Operation 2052B: Update the initial label of the to-be-classified sub-sample for the i^{th} time with reference to the i^{th} update vector and a sub-sample vector corresponding to the to-be-classified sub-sample, to obtain an i^{th} update label of the to-be-classified sub-sample.

In some embodiments, the updating the initial label of the to-be-classified sub-sample for the i^{th} time with reference to the i^{th} update vector and a sub-sample vector corresponding to the to-be-classified sub-sample, to obtain an i^{th} update label of the to-be-classified sub-sample may be implemented in the following manner: obtaining similarity between the i^{th} update vector and the sub-sample vector corresponding to the to-be-classified sub-sample; and when i is equal to 1, performing label update on the initial label of the to-be-classified sub-sample based on the similarity, to obtain a first update label of the to-be-classified sub-sample; or when i is greater than 1, updating an (i−1)^{th} update label of the to-be-classified sub-sample based on the similarity, to obtain the i^{th} update label of the to-be-classified sub-sample.

As an example, an expression of similarity between the i^{th} update vector and the sub-sample vector corresponding to the to-be-classified sub-sample may be:

$$s i {m}_{i}^{j , e} = mathop arg max {1}_{c} ( {E}_{prototype}^{e} * {( {h}_{i}^{j , e} )}^{T} ) \qquad ( 16 )$$

where

$$s i {m}_{i}^{j , e}$$

is configured for indicating similarity between the i^{th} update vector and the sub-sample vector corresponding to the to-be-classified sub-sample, mathopargmax1_{c} is configured for indicating a similarity function,

$${E}_{p r o t o t y p e}^{e}$$

is configured for indicating the i^{th} update vector, and

$${h}_{i}^{j , e}$$

is configured for indicating a sub-sample vector corresponding to a to-be-classified sub-sample.

In some embodiments, the performing label update on the initial label of the to-be-classified sub-sample based on the similarity, to obtain a first update label of the to-be-classified sub-sample may be implemented in the following manner: obtaining a label value of the initial label of the to-be-classified sub-sample, performing standardization processing on the similarity to obtain a corresponding standard value of similarity, performing weighted summation on the standard value and the label value of the initial label to obtain a target label value of the first update label, obtaining a target label corresponding to the target label value, and determining the target label as the first update label.

In some embodiments, the obtaining a label value of the initial label of the to-be-classified sub-sample may be implemented in the following manner: obtaining a mapping relationship between a label value and a label; querying, based on the mapping relationship between a label value and a label, a target index entry that includes the initial label; and determining a label value in the target index entry as the label value of the initial label of the to-be-classified sub-sample.

In some embodiments, the obtaining a target label corresponding to the target label value may be implemented in the following manner: obtaining a mapping relationship between a label value and a label; querying, based on the mapping relationship between a label value and a label, a reference index entry that includes the target label value; and determining a reference label in the reference index entry as the target label of the target label value.

Operation 2053B: When i is greater than or equal to 2 and the i^{th} update label is the same as an (i−1)^{th} update label, determine the i^{th} update label as the target label of the to-be-classified sub-sample.

In some embodiments, when i is greater than or equal to 2 and the i^{th} update label is the same as the (i−1)^{th} update label, that is, the i^{th} update label obtained by label updating for the i^{th} time is the same as the (i−1)^{th} update label obtained by label updating for the (i−1)^{th} time, it indicates that label update tends to be stable. In this case, the i^{th} update label may be determined as the target label of the to-be-classified sub-sample.

Operation 2054B: When i is equal to 1 and a first update label is the same as the initial label, determine the first update label as the target label of the to-be-classified sub-sample.

In some embodiments, 1≤i≤N, and N is configured for indicating a maximum number of times of updating the initial label of the to-be-classified sub-sample.

In some embodiments, when i is equal to 1 and the first update label is the same as the initial label, it indicates that the initial label matches the first update label, that is, it indicates that the first label update already verifies the accuracy of the initial label. In this case, the first update label may be directly determined as the target label of the to-be-classified sub-sample.

In this way, the initial label of the to-be-classified sub-sample is updated for N rounds, when i is greater than or equal to 2 and the i^{th} update label is the same as an (i−1)^{th} update label, the i^{th} update label is determined as the target label of the to-be-classified sub-sample; or when i is equal to 1 and a first update label is the same as the initial label, the first update label is determined as the target label of the to-be-classified sub-sample. Therefore, accuracy of the target label of the to-be-classified sub-sample is improved, so that the target label can accurately reflect the category of the to-be-classified sub-sample.

Operation 206: Train the classification model with reference to the prediction probability, the initial label, and the target label, to obtain a target classification model.

In some embodiments, the target classification model is configured to perform category prediction on each to-be-classified sub-image in a to-be-classified image, to obtain a prediction probability of each to-be-classified sub-image.

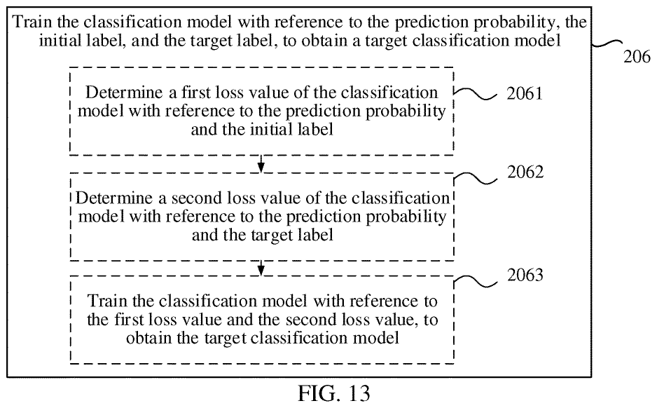

In some embodiments, FIG. 13 is a fourth schematic flowchart of an image classification model training method according to an embodiment of this application. Operation 206 shown in FIG. 9 may be implemented through operation 2061 to operation 2063 shown in FIG. 13.

Operation 2061: Determine a first loss value of the classification model with reference to the prediction probability and the initial label.

In some embodiments, the prediction probability includes a prediction sub-probability in a one-to-one correspondence with each candidate category, and operation 2061 may be implemented in the following manner: multiplying each prediction sub-probability by the category value corresponding to the initial label, to obtain a first reference loss value of the prediction sub-probability, and adding first reference loss values to obtain the second reference loss value; obtaining a reference probability corresponding to each prediction sub-probability and a reference category value corresponding to the initial label; multiplying each reference probability by the reference category value, to obtain a third reference loss value corresponding to each reference probability, and adding third reference loss values to obtain a fourth reference loss value; and adding the second reference loss value and the fourth reference loss value, to obtain the first loss value.

In some embodiments, a sum of the reference probability and the corresponding prediction sub-probability is equal to 1, and a sum of the reference category value and the category value is equal to 1.

As an example, an expression of the first reference loss value may be:

$$L 1 = Y * log ( {p}_{i} ) \qquad ( 17 )$$

where L1 is configured for indicating the first reference loss value, Y is configured for indicating a category value corresponding to the initial label, and pᵢ is configured for indicating each prediction sub-probability.

As an example, an expression of the second reference loss value may be:

$$L 2 = {\sum }_{i = 1}^{N} Y * log ( {p}_{i} ) \qquad ( 18 )$$

where L2 is configured for indicating the second reference loss value, and Y*log (pᵢ) is configured for indicating each first reference loss value.

As an example, an expression of the third reference loss value corresponding to the reference probability may be:

$$L 3 = ( 1 - {Y}_{i} ) * log ( 1 - {p}_{i} ) \qquad ( 19 )$$

where L3 is configured for indicating a third reference loss value corresponding to a reference probability, log (1−pᵢ) is configured for indicating a reference probability, and (1−Yᵢ) is configured for indicating a reference category value.

As an example, an expression of the fourth reference loss value may be:

$$L 4 = {\sum }_{i = 1}^{N} ( 1 - {Y}_{i} ) * log ( 1 - {p}_{i} ) \qquad ( 20 )$$

where L4 is configured for indicating a fourth reference loss value, and (1−Y₁)*log (1−pᵢ) is configured for indicating a third reference loss value corresponding to each reference probability.

As an example, an expression of the first loss value is:

$$L = L 2 + L 4 \qquad ( 21 )$$

where L is configured for indicating a first loss value, L2 is configured for indicating a second reference loss value, and L4 is configured for indicating a fourth reference loss value.

In this way, the first loss value of the classification model is determined with reference to the prediction probability and the initial label, so that the loss of the classification model is considered from the perspective of the initial label, to obtain the corresponding first loss value, thereby facilitating subsequent training of the classification model based on the first loss value, to obtain the target classification model.

Operation 2062: Determine a second loss value of the classification model with reference to the prediction probability and the target label.

In some embodiments, the prediction probability includes a prediction sub-probability in a one-to-one correspondence with each candidate category, and operation 2062 may be implemented in the following manner: multiplying each prediction sub-probability by the category value corresponding to the target label, to obtain a first target loss value of the prediction sub-probability, and adding first target loss values to obtain the second target loss value; obtaining a reference probability corresponding to each prediction sub-probability and a target category value corresponding to the target label; multiplying each reference probability by the target category value, to obtain a third target loss value corresponding to each reference probability, and adding third target loss values to obtain a fourth target loss value; and adding the second target loss value and the fourth target loss value, to obtain the second loss value.

In some embodiments, a sum of the reference probability and the corresponding prediction sub-probability is equal to 1, and a sum of the reference category value and the category value is equal to 1.

As an example, an expression of the first target loss value may be:

$$F 1 = {Y}^{e} * log ( {p}_{i} ) \qquad ( 22 )$$

where F1 is configured for indicating a first target loss value, Y^{e} is configured for indicating a category value corresponding to the target label, and pᵢ is configured for indicating each prediction sub-probability.

As an example, an expression of the second target loss value may be:

$$F 2 = {\sum }_{i = 1}^{N} {Y}^{e} * log ( {p}_{i} ) \qquad ( 23 )$$

where F2 is configured for indicating a second target loss value, and Y^{e}*log (pᵢ) is configured for indicating a first target loss value.

As an example, an expression of the third target loss value may be:

$$F 3 = ( 1 - {Y}^{e} ) * log ( 1 - {p}_{i} ) \qquad ( 24 )$$

where F3 is configured for indicating a third target loss value, (1−Y^{e}) is configured for indicating a reference probability corresponding to each prediction sub-probability, and log (1−pᵢ) is configured for indicating a target category value corresponding to the target label.

As an example, an expression of the fourth target loss value may be:

$$F 4 = {\sum }_{i = 1}^{N} ( 1 - {Y}^{e} ) * log ( 1 - {p}_{i} ) \qquad ( 25 )$$

where F4 is configured for indicating a fourth target loss value, and (1−Y^{e})*log (1−pᵢ) is configured for indicating a third target loss value.

As an example, an expression of the second loss value is:

$$F = F 2 + F 4 \qquad ( 26 )$$

where F is configured for indicating a second loss value, F2 is configured for indicating a second target loss value, and F4 is configured for indicating a fourth target loss value.

In this way, the second loss value of the classification model is determined with reference to the prediction probability and the target label, so that the loss of the classification model is considered from the perspective of the target label, to obtain the corresponding second loss value, thereby facilitating subsequent training of the classification model based on the second loss value, to obtain the target classification model.

Operation 2063: Train the classification model with reference to the first loss value and the second loss value, to obtain the target classification model.

In some embodiments, the training the classification model with reference to the first loss value and the second loss value, to obtain the target classification model may be implemented in the following manner: performing weighted summation on the first loss value and the second loss value, to obtain a target loss value, and training the classification model based on the target loss value, to obtain the target classification model.

As an example, an expression of the target loss value is:

$$W = L + F \qquad ( 27 )$$

where W is configured for indicating a target loss value, F is configured for indicating a second loss value, and L is configured for indicating a first loss value.

In this way, the first loss value of the classification model is determined with reference to the prediction probability and the initial label, so as to consider a loss of the classification model from the perspective of the initial label, to obtain the corresponding first loss value. The second loss value of the classification model is determined with reference to the prediction probability and the target label, so as to consider the loss of the classification model from the perspective of the target label, to obtain the corresponding second loss value. The classification model is trained with reference to the first loss value and the second loss value, to obtain the target classification model, so that in the obtained target classification model, the loss of the classification model is considered from both the perspective of the initial label and the perspective of the target label, thereby effectively improving classification performance of the target classification model obtained through training.

In this way, the following processing is performed on each to-be-classified sub-sample by traversing i, until the target label of the to-be-classified sub-sample is obtained: determining an i^{th} update vector based on the prediction probability of each to-be-classified sub-sample, where the i^{th} update vector is configured for updating the initial label of the to-be-classified sub-sample for the i^{th} time; updating the initial label of the to-be-classified sub-sample for the i^{th} time with reference to the i^{th} update vector and a sub-sample vector corresponding to the to-be-classified sub-sample, to obtain an i^{th} update label of the to-be-classified sub-sample; and when i is greater than or equal to 2 and the i^{th} update label is the same as an (i−1)^{th} update label, determining the i^{th} update label as the target label of the to-be-classified sub-sample; or when i is equal to 1 and a first update label is the same as the initial label, determining the first update label as the target label of the to-be-classified sub-sample. Therefore, N rounds of label disambiguation are performed on the initial label, so that the accuracy of the obtained target label is higher.

Next, an exemplary application of the embodiments of this application in an actual application scenario of an immune receptor repertoire is described.

The human immune system includes innate immunity and adaptive immunity. Adaptive immunity is that after T cells and B cells come in contact with a pathogen (an antigen), an immune response that can recognize and eliminate a particular pathogen is generated. An adaptive immune receptor repertoire (an immune repertoire for short) is a set of human T cell receptors (TCR) or B cell receptors (BCR), and records past and ongoing adaptive immune responses. A status of the immune repertoire may be used to reflect an immune activity status and responses of an individual to an infective illness, an immune illness of the individual, and a tumor-associated pathogen. Therefore, research on a TCR immune repertoire or a BCR immune repertoire may be applied to fields such as prediction of an immune status after human vaccination or infection, prediction of a human illness status, especially a caner and an immune-type illness, and design of an immune treatment.

According to the image classification model training method and the image classification method provided in the embodiments of this application, an accurate sequence-level classifier can be trained without an accurate label. This not only can integrate prediction of each TCR/BCR sequence to perform repertoire-level classification, but also can explore an illness-related TCR/BCR sequence in a repertoire.

A massive adaptive immune receptor repertoire (AIRR) includes a set of massive adaptive immune receptors (a collective name of AIR, TCR, and BCR). Assuming that there are N AIRRs, a mathematical expression thereof is {IR₁, IR₂, . . . , IR_{N}}. Each AIRR includes M AIRs, which are represented as

$$\{ {IR}_{i}^{1} , {IR}_{i}^{2} , … , {IR}_{i}^{M} \} .$$

M in immune repertoires of different individuals varies greatly. In addition, labels of the N immune repertoires are defined as {Y₁, Y₂, . . . , Y_{N}}, where Y∈{0, . . . , C}, and C represents a quantity of categories. For example, in a case of binary classification, C=1. In addition, each AIR has a corresponding frequency, which is represented as

$$\{ {f}_{i}^{1} , {f}_{i}^{2} , … , {f}_{i}^{M} \} .$$

The frequency indicates strength of an immune response to a particular antigen. In this embodiment of this application, a mapping function Y=F(IR) may be established, to convert the immune repertoire (IR) to an immune status Y. In this embodiment of this application, a repertoire label Yᵢ (a packet-level label) is initially assigned to receptors

$$\{ {IR}_{i}^{1} , {IR}_{i}^{2} , … , {IR}_{i}^{M} \}$$

a pseudo-labels. Subsequently, these pseudo-labels are updated to appropriate values.

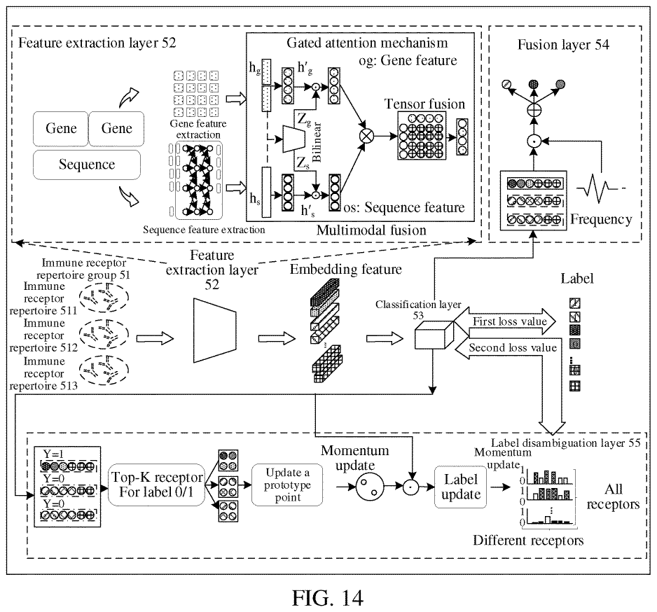

In some embodiments, FIG. 14 is a schematic diagram of a principle of an image classification method according to an embodiment of this application. In an actual application stage, an immune receptor repertoire group 51 (AIRR) includes an immune receptor repertoire 511, an immune receptor repertoire 512, and an immune receptor repertoire 513, and the immune receptor repertoire 511, the immune receptor repertoire 512, and the immune receptor repertoire 513 all include a plurality of immune receptors. Each immune receptor repertoire in the immune receptor repertoire group 51 is encoded by invoking the encoding layer 52, to obtain an embedding feature of the immune receptor repertoire. Each immune receptor is classified based on a receptor embedding feature of each immune receptor in each immune receptor repertoire by invoking the classification layer 53, to obtain a category of each immune receptor. The fusion layer 54 is invoked for each immune receptor repertoire, to fuse the category of each immune receptor in the immune receptor repertoire with a frequency corresponding to the immune receptor, to obtain a category of the immune receptor repertoire. In a training stage, an initial classification layer is trained by using a label disambiguation layer 55 shown in FIG. 14, to obtain the classification layer 53.

In some embodiments, referring to FIG. 14, the encoding layer 52 shown in FIG. 14 is described below by using an immune receptor repertoire 511 as an example. To obtain a comprehensive representation of each immune receptor in the immune receptor repertoire 511, for each immune receptor in the immune receptor repertoire 511, multimodality fusion can be used to fuse genes (for example, V (D) J gene segments) and sequences (for example, amino acid (AA) sequences) of the immune receptor. A gated attention mechanism may be used in the encoding layer 52, and then tensor fusion is performed. Specifically, a gene encoder including a trainable embedding layer performs genetic encoding on digitalized V (D) J gene segments, to obtain a converted digit vector marked as h_{g}. An embedding dimension of the V gene segment (TCRBV11) is 16, and an embedding dimension of the J gene segment (TCRBJ02) is 8. In addition, sequence encoding is performed on the sequence by using a pre-trained sequence encoder (a pre-trained immune receptor model), to generate a sequence representation of the immune receptor, which is defined as hₛ, where an embedding dimension thereof may be 512. The pre-trained immune receptor model is a model similar to BERT, and includes 6 standard transform layers, and each layer further includes 4 attention heads.

In some embodiments, referring to FIG. 14, based on the gated attention mechanism, an expression of a gene feature Og shown in FIG. 14 may be:

$${o}_{g} = σ ( {z}_{g} ) * {h}_{g}^{′} \qquad ( 28 )$$

where z_{g} is a bilinear transformation result of a converted digit vector h_{g} and a sequence representation hₛ of an immune receptor, and an expression of z_{g} may be:

$${z}_{g} = {h}_{g}^{T} {W}_{g s} {h}_{s} + {b}_{g s} \qquad ( 29 )$$

where b_{gs} is a weight matrix parameter for learning based on the gated attention mechanism.

$${h}_{g}^{′}$$

is a linear transformation result of a converted digit vector h_{g}, and an expression of

$${h}_{g}^{′}$$

may be:

$${h}_{g}^{′} = ReLu ( {W}_{g} * {h}_{g} + {b}_{g} ) \qquad ( 30 )$$

where W_{g} and b_{g} are weight matrix parameters for learning based on the gated attention mechanism, ReLu is configured for indicating an activation function, and σ is configured for indicating an activation function.

In some embodiments, referring to FIG. 14, based on the gated attention mechanism, an expression of a sequence feature Os shown in FIG. 14 may be:

$${o}_{s} = σ ( {z}_{s} ) * {h}_{s}^{′} \qquad ( 31 )$$

where zₛ is a bilinear transformation result of a converted digit vector h_{g} and a sequence representation hₛ of an immune receptor, and an expression of zₛ may be:

$${z}_{s} = {h}_{s}^{T} {W}_{s g} {h}_{s} + {b}_{s g} \qquad ( 32 )$$

where b_{sg} is a weight matrix parameter for learning based on the gated attention mechanism.

$${h}_{s}^{′}$$

is a linear transformation result of a sequence representation hₛ of an immune receptor, and an expression of

$${h}_{s}^{′}$$

may be:

$${h}_{s}^{′} = R e L u ( {W}_{s} * {h}_{s} + {b}_{s} ) \qquad ( 33 )$$

where bₛ and Wₛ are weight matrix parameters for learning based on the gated attention mechanism, and ReLu is configured for indicating an activation function.

In some embodiments, referring to FIG. 14, tensor fusion is used to fuse o_{g} and oₛ to obtain a final representation h, and an expression of the final representation h may be:

$$h = R e L u ( {W}_{fusion} * ( {o}_{g} ⊗ {o}_{s} ) + {b}_{fusion} ) \qquad ( 34 )$$

where W_{fusion} and b_{fusion} are learnable parameters of tensor fusion, and ⊗ is a Kronecker product.

In some embodiments, referring to FIG. 14, the label disambiguation layer 55 shown in FIG. 14 is described below. After the representation of the receptor is obtained by using the encoder, a predicted value of each receptor is calculated as follows:

$${p}_{i}^{j} = softmax ( {FC}_{receptor} ( {h}_{i}^{j} ) ) , \qquad ( 35 )$$

FC_{receptor} is a classifier and learnable parameters are

$${W}_{fc}^{receptor} and {b}_{fc}^{receptor} , {p}_{i}^{j}$$

is a prediction probability of a multimodal representation of a j^{th} immune receptor

$${h}_{i}^{j}$$

in an i^{th} immune repertoire.

Then, in this embodiment of this application, a set kec-receptor is defined and K immune receptors are selected for each category c∈{0, . . . , C}. In an e^{th} round of training,

$${p}_{i}^{k}$$

values thereof all exceed a threshold θ. An expression of the set kec-receptor may be:

$$kec - receptor = {h}_{i}^{k , e , c} \vert {p}_{i}^{k , e , c} > θ , c ∈ \{ 0 , ⋯ , C \} , k ∈ \{ 0 , K \} , i ∈ \{ 0 , N \} \} \qquad ( 36 )$$

Next, in this embodiment of this application, a momentum based update method is used to update prototype points. Specifically, a representations of a category c in the prototype points in the (e+1)^{th} training round is updated based on representations of selected K receptors in the e^{th} round. A calculation manner thereof is as follows:

$${E}_{{prototype}^{}}^{c , e + 1} = Norm alize ( λ * {E}_{{prototype}^{}}^{c , e} + ( 1 - λ ) * {h}_{i}^{k , e , c} ) , {h}_{i}^{k , e , c} ∈ kec - receptor , c ∈ \{ 0 , 1 \} \qquad ( 37 )$$

where λ∈[0,1] is a momentum update coefficient.

Finally, a label

$${Y}_{i}^{j}$$

of each immune receptor (initially set as a label Yᵢ of a corresponding immune repertoire) can be adjusted based on similarity between the immune receptor and a prototype point in the e^{th} training round.

$${Y}_{i}^{j , e + 1} = γ * {Y}_{i}^{j , e} + ( 1 - γ ) * Onehot ( {sim}_{i}^{j , e} ) \qquad ( 38 )$$

where γ is also a momentum update coefficient,

$$s i {m}_{i}^{j , e}$$

is similarity between an immune receptor and a prototype point in an e^{th} training round, mathopargmax is a similarity function, and

$$s i {m}_{i}^{j , e}$$

is defined as:

$$si {m}_{i}^{j , e} = mathopargmax ( {E}_{prototype}^{e} * {( {h}_{i}^{j , e} )}^{T} ) \qquad ( 39 )$$

In some embodiments, referring to FIG. 14, the following describes the fusion layer 54 shown in FIG. 14. To generate a prediction value of an immune repertoire pᵢ, in this embodiment of this application, a corresponding prediction value of a corresponding immune receptor

$${p}_{i}^{j}$$

and a corresponding frequency

$${fre}_{i}^{j}$$

are fused as follows:

$${p}_{i} = sum ( {p}_{i}^{j} * f r {e}_{i}^{j} ) . \qquad ( 40 )$$

Then, a final immune repertoire prediction result is outputted through minimum-maximum normalization.

In some embodiments, referring to FIG. 14, the following describes the first loss value and the second loss value shown in FIG. 14. A training stage includes a preliminary stage and a label disambiguation stage. In the preliminary stage, prototype point update and label disambiguation are temporarily suspended. In this case, the first loss value is obtained by calculating a cross-entropy loss between a prediction result

$${p}_{i}^{j}$$

and an initial label

$${Y}_{i}^{j}$$

based on a loss function, and an expression of the first loss value may be:

$${L}_{receptor} = - \frac{1}{NM} {\sum }_{i = 1}^{N} {\sum }_{j = 1}^{M} {Y}_{i}^{j} * log ( {p}_{i}^{j} ) + ( 1 - {Y}_{i}^{j} ) * log ( 1 - {p}_{i}^{j} ) \qquad ( 41 )$$

In a label disambiguation stage, a label disambiguation loss L_{disambiguation} between a prediction result

$${p}_{i}^{j , e}$$

and an adjusted label

$${Y}_{i}^{j , e}$$

is calculated, that is, the second loss value, to supervise a model parameter. An expression of the second loss value may be:

$${L}_{disambiguaton} = - \frac{1}{NM} {\sum }_{i = 1}^{N} {\sum }_{j = 1}^{M} {Y}_{i}^{j , e} * log ( {p}_{i}^{j , e} ) + ( 1 - {Y}_{i}^{j , e} ) * log ( 1 — {p}_{i}^{j , e} ) \qquad ( 42 )$$

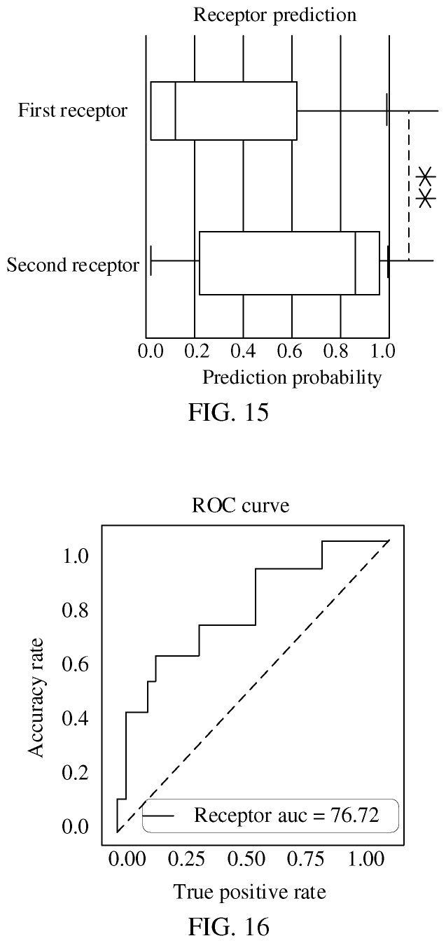

In some embodiments, FIG. 15 is a first schematic diagram of a classification effect of an image classification method according to an embodiment of this application. FIG. 15 shows prediction distribution of a first receptor (a CMV-related sequence) and a second receptor (another sequence). A prediction probability of the first receptor is mainly distributed within a probability interval of 0 to 0.6, and a prediction probability of the second receptor is mainly distributed within a probability interval of 0.2 to 1.0. FIG. 16 is a second schematic diagram of a classification effect of an image classification method according to an embodiment of this application. FIG. 16 shows an ROC curve for recognition of a CMV-related receptor. When a true positive rate is 0.25, a corresponding accuracy rate is 0.6.

In this way, in this embodiment of this application, modeling of the issue of classification of the immune system is reconsidered. A new modeling idea is provided: a simple sequence-level classifier plus robust training. For a special noise label converted from a repertoire-level label, in implementation of this embodiment of this application, a repertoire status may be inferred. This drives many frontier research fields such as treatment of infected and immune illness and design of cancer vaccines.

In this way, the to-be-classified image is converted between different modalities including a plurality of to-be-classified sub-images, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image; category prediction is performed on each to-be-classified sub-image based on the to-be-classified sub-vector corresponding to each to-be-classified sub-image, to obtain a category prediction probability of the to-be-classified sub-image; and the to-be-classified image is classified based on the category prediction probability corresponding to each to-be-classified sub-image, to obtain the category of the to-be-classified image. In this way, modality fusion is performed on modality information obtained by converting the to-be-classified image between different modalities, so that the obtained multimodal vector can accurately reflect modality features of the to-be-classified image from different modalities. In addition, the to-be-classified image is encoded based on the multimodal vector, to obtain the to-be-classified vector, thereby effectively increasing an information amount of the to-be-classified vector. Besides, category prediction is performed on each to-be-classified sub-image based on the to-be-classified vector corresponding to the to-be-classified sub-image. Because the to-be-classified vector on which category prediction is based has a more comprehensive information amount, a category prediction probability obtained through prediction is more accurate. The to-be-classified image is classified based on the accurate category prediction probability, thereby effectively improving information classification accuracy.

In the embodiments of this application, related data such as to-be-classified images are involved. When the embodiments of this application are used in specific products or technologies, user permission or consent needs to be obtained, and the collection, use, and processing of relevant data need to comply with the relevant laws, regulations, and standards of the relevant countries and regions.

The following describes an exemplary structure of an image classification apparatus 455 implemented as software modules according to an embodiment of this application. In some embodiments, as shown in FIG. 2, the software modules in the image classification apparatus 455 stored in the memory 450 may include: an obtaining module 4551, configured to obtain a to-be-classified image including a plurality of to-be-classified sub-images, and converting the to-be-classified image between different modalities, to obtain modality information of the to-be-classified image that corresponds to each modality; a modality fusion module 4552, configured to perform modality fusion on all pieces of modality information, to obtain a multimodal vector corresponding to the to-be-classified image; an encoding module 4553, configured to encode the to-be-classified image based on the multimodal vector, to obtain a to-be-classified vector corresponding to the to-be-classified image, where the to-be-classified vector includes a to-be-classified sub-vector in a one-to-one correspondence with each to-be-classified sub-image; and a category prediction module 4554, configured to classify the to-be-classified image based on the to-be-classified sub-vector corresponding to each to-be-classified sub-image, to obtain the category of the to-be-classified image.

In some embodiments, the multimodal vector includes a multimodal sub-vector corresponding to each piece of modality information, and the modality fusion module is further configured to: encode each piece of modality information, to obtain a modal vector corresponding to the modality information; and perform the following processing on each piece of modality information: determining the modality information as target modality information, and determining each piece of modality information other than the target modality information as reference modality information; performing vector conversion on a modal vector corresponding to the target modality information, to obtain a target modal vector corresponding to the target modality information; performing vector fusion on the modal vector corresponding to the target modality information and a modal vector corresponding to each reference modality information, to obtain a intermediate multimodal sub-vector corresponding to the target modality information; and performing vector fusion on the intermediate multimodal sub-vector and the target modal vector, to obtain a multimodal sub-vector corresponding to the target modality information.

In some embodiments, the modality fusion module is further configured to: obtain a target conversion vector corresponding to the target modality information and a target correction vector corresponding to the target modality information, where a vector dimension of the modal vector corresponding to the target modality information is the same as both vector dimensions of the corresponding target conversion vector and the corresponding target correction vector; multiply the modal vector corresponding to the target modality information by the target conversion vector, to obtain a converted modal vector corresponding to the target modality information; add the target conversion vector and the target correction vector, to obtain an intermediate target modal vector corresponding to the target modality information; and perform vector activation on the target correction vector, to obtain the target modal vector corresponding to the target modality information.

In some embodiments, the modality fusion module is further configured to: obtain a reference conversion vector corresponding to the target modality information and a reference correction vector corresponding to the target modality information, where a vector dimension of the modal vector corresponding to the target modality information is the same as both vector dimensions of the corresponding reference conversion vector and the corresponding reference correction vector; perform vector transposition on the modal vector corresponding to the target modality information, to obtain a transposed target modal vector corresponding to the target modality information; multiply the transposed target modal vector by the corresponding reference conversion vector, to obtain a first reference vector, and multiply the first reference vector by the modal vector, to obtain a second reference vector; and add the reference correction vector corresponding to the target modality information and the second reference vector, to obtain the intermediate multimodal sub-vector corresponding to the target modality information.

In some embodiments, the multimodal vector includes a multimodal sub-vector corresponding to each piece of modality information, and the encoding module is further configured to: obtain vector dimensions of all multimodal sub-vectors, and determine an average value of the vector dimensions as a target dimension; adjust vector dimensions of all the multimodal sub-vectors to the target dimension, to obtain adjusted multimodal sub-vectors corresponding to all the multimodal sub-vectors; and multiply the adjusted multimodal sub-vectors, to obtain a reference multimodal vector, and correct the reference multimodal vector based on a correction parameter, to obtain the to-be-classified vector corresponding to the to-be-classified image.

In some embodiments, the encoding module is further configured to: obtain a first correction parameter and a second correction parameter, and multiply the reference multimodal vector by the first correction parameter, to obtain a intermediate to-be-classified vector corresponding to the to-be-classified image; and add the intermediate to-be-classified vector and the second correction parameter, to obtain the to-be-classified vector corresponding to the to-be-classified image.

In some embodiments, the category prediction is implemented through a target classification model, and the image classification apparatus further includes: a training module, configured to: obtain a to-be-classified image sample including a plurality of to-be-classified sub-samples, and a sample label carried in the to-be-classified image sample; encode the to-be-classified image sample, to obtain a sample vector corresponding to the to-be-classified image sample, the sample vector including a sub-sample vector in a one-to-one correspondence with each to-be-classified sub-sample; determine, for each to-be-classified sub-sample, the sample label as an initial label of the to-be-classified sub-sample, and invoke the classification model to perform category prediction on the to-be-classified sub-sample based on the sub-sample vector corresponding to the to-be-classified sub-sample, to obtain a predicted probability of the to-be-classified sub-sample; determine a target label of each to-be-classified sub-sample based on the predicted probability of the to-be-classified sub-sample; and train the classification model with reference to the predicted probability, the initial label, and the target label, to obtain a target classification model.

In some embodiments, the category prediction probability includes a category probability in a one-to-one correspondence with each candidate category, the category probability is configured for indicating a probability that the to-be-classified sub-image is the corresponding candidate category, and the classification module is further configured to: obtain a weight coefficient corresponding to each to-be-classified sub-image, where the weight coefficient is configured for indicating importance of the to-be-classified sub-image in the to-be-classified image; perform, based on all weight coefficients, weighted summation on category prediction probabilities corresponding to all to-be-classified sub-images, to obtain target prediction probabilities corresponding to the to-be-classified image; where the target prediction probabilities include a target probability in a one-to-one correspondence with each candidate category; and determine a candidate category having a highest target probability as the category of the to-be-classified image.

In some embodiments, the obtaining module is further configured to: when the to-be-classified image is multimodality information, obtain each target modality of the to-be-classified image, and extract, for each target modality, modality information in the target modality from the to-be-classified image, to obtain modality information of the to-be-classified image that corresponds to the target modality; or when the to-be-classified image is single-modality information, obtain a plurality of target modalities, and for each target modality, convert the to-be-classified image to the target modality, to obtain modality information of the to-be-classified image that corresponds to the target modality.

The following describes an exemplary structure of the image classification model training apparatus 555 provided in the embodiments of this application implemented as software modules. In some embodiments, as shown in FIG. 3, software modules in the image classification apparatus 555 stored in the memory 550 may include: a sample obtaining module 5551, a sample encoding module 5552, a sample prediction module 5553, a label determining module 5554, and a target training module 5555. The sample obtaining module is configured to obtain a to-be-classified image sample including a plurality of to-be-classified sub-samples, and a sample label carried in the to-be-classified image sample. The sample encoding module is configured to encode the to-be-classified image sample, to obtain a sample vector corresponding to the to-be-classified image sample, the sample vector including a sub-sample vector in a one-to-one correspondence with each to-be-classified sub-sample. The sample prediction module is configured to determine, for each to-be-classified sub-sample, the sample label as an initial label of the to-be-classified sub-sample, and invoke the classification model to perform category prediction on the to-be-classified sub-sample based on the sub-sample vector corresponding to the to-be-classified sub-sample, to obtain a predicted probability of the to-be-classified sub-sample. The label determining module is configured to determine a target label of each to-be-classified sub-sample based on the predicted probability of the to-be-classified sub-sample. The target training module is configured to train the classification model with reference to the predicted probability, the initial label, and the target label, to obtain a target classification model; the target classification model being configured to perform category prediction on each to-be-classified sub-image in a to-be-classified image, to obtain a predicted probability of each to-be-classified sub-image.

In some embodiments, the prediction probability includes a prediction sub-probability in a one-to-one correspondence with each candidate category, and the label determining module is further configured to: perform the following processing on each to-be-classified sub-sample: determining a highest prediction sub-probability of the prediction probabilities of the to-be-classified sub-sample as a reference prediction probability of the to-be-classified sub-sample; and determining the candidate category corresponding to the reference prediction probability as the target label of the to-be-classified sub-sample.

In some embodiments, the label determining module is further configured to perform the following processing on each to-be-classified sub-sample by traversing i, until the target label of the to-be-classified sub-sample is obtained: determining an i^{th} update vector based on the prediction probability of each to-be-classified sub-sample, where the i^{th} update vector is configured for updating the initial label of the to-be-classified sub-sample for the i^{th} time; updating the initial label of the to-be-classified sub-sample for the i^{th} time with reference to the i^{th} update vector and a sub-sample vector corresponding to the to-be-classified sub-sample, to obtain an i^{th} update label of the to-be-classified sub-sample; and when i is greater than or equal to 2 and the i^{th} update label is the same as an (i−1)^{th} update label, determining the i^{th} update label as the target label of the to-be-classified sub-sample; or when i is equal to 1 and a first update label is the same as the initial label, determining the first update label as the target label of the to-be-classified sub-sample; where 1≤i≤N, and N is configured for indicating a maximum number of times of updating the initial label of the to-be-classified sub-sample.

In some embodiments, the label determining module is further configured to: when i is equal to 1, determine a first update vector based on the prediction probability of each to-be-classified sub-sample; or when i is greater than or equal to 2, perform vector update on the first update vector for an (i−1)^{th} time based on the sub-sample vector corresponding to the to-be-classified sub-sample, to obtain the i^{th} update vector.

In some embodiments, the prediction probability includes a prediction sub-probability in a one-to-one correspondence with each candidate category, and the label determining module is further configured to: for each candidate category, select, from the plurality of to-be-classified sub-samples based on the prediction probability of each to-be-classified sub-sample, a target sub-sample corresponding to the candidate category, and determine, based on a sub-sample vector corresponding to the target sub-sample, a category update vector corresponding to the candidate category; where a prediction sub-probability that is of the prediction probabilities of the target sub-sample and that corresponds to the candidate category is greater than a probability threshold; and perform vector fusion on category update vectors, to obtain the first update vector.

In some embodiments, the label determining module is further configured to perform the following processing for each to-be-classified sub-sample: determining, as a target sub-probability that is of the to-be-classified sub-sample and that corresponds to the candidate category, a prediction sub-probability that is of prediction probabilities of the to-be-classified sub-sample and that corresponds to the candidate category; and when the target sub-probability is greater than the probability threshold, determining the to-be-classified sub-sample as the target sub-sample corresponding to the candidate category.

In some embodiments, the label determining module is further configured to: when there is one target sub-sample, determine the sub-sample vector corresponding to the target sub-sample as the category update vector corresponding to the candidate category; or when there is a plurality of target sub-samples, perform vector fusion on sub-sample vectors respectively corresponding to the target sub-samples, to obtain the category update vector corresponding to the candidate category.

In some embodiments, the label determining module is further configured to: when i is equal to 2, perform weighted fusion on the first update vector and the sub-sample vector corresponding to the to-be-classified sub-sample, to obtain a second update vector; or when i is greater than or equal to 2, perform weighted fusion on the (i−1)^{th} update vector and the sub-sample vector corresponding to the to-be-classified sub-sample, to obtain the i^{th} update vector.

In some embodiments, the label determining module is further configured to: obtain similarity between the i^{th} update vector and the sub-sample vector corresponding to the to-be-classified sub-sample; and when i is equal to 1, perform label update on the initial label of the to-be-classified sub-sample based on the similarity, to obtain a first update label of the to-be-classified sub-sample; or when i is greater than 1, update an (i−1)^{th} update label of the to-be-classified sub-sample based on the similarity, to obtain the i^{th} update label of the to-be-classified sub-sample.

In some embodiments, the label determining module is further configured to perform the following processing for each to-be-classified sub-sample: determining a highest prediction sub-probability of the prediction probabilities of the to-be-classified sub-sample as a reference prediction probability of the to-be-classified sub-sample; and determining the candidate category corresponding to the reference prediction probability as the target label of the to-be-classified sub-sample.

In some embodiments, the target training module is further configured to: determine a first loss value of the classification model with reference to the prediction probability and the initial label, and determine a second loss value of the classification model with reference to the prediction probability and the target label; and train the classification model with reference to the first loss value and the second loss value, to obtain the target classification model.

In some embodiments, the prediction probability includes a prediction sub-probability in a one-to-one correspondence with each candidate category, and the target training module is further configured to: multiply each prediction sub-probability by the category value corresponding to the initial label, to obtain a first reference loss value of the prediction sub-probability, and add first reference loss values to obtain the second reference loss value; obtain a reference probability corresponding to each prediction sub-probability and a reference category value corresponding to the initial label, where a sum of the reference probability and the corresponding prediction sub-probability is equal to 1, and a sum of the reference category value and the category value is equal to 1; multiply each reference probability by the reference category value, to obtain a third reference loss value corresponding to each reference probability, and add third reference loss values to obtain a fourth reference loss value; and add the second reference loss value and the fourth reference loss value, to obtain the first loss value.

In some embodiments, the prediction probability includes a prediction sub-probability in a one-to-one correspondence with each candidate category, and the target training module is further configured to: multiply each prediction sub-probability by the category value corresponding to the target label, to obtain a first target loss value of the prediction sub-probability, and add first target loss values to obtain the second target loss value; obtain a reference probability corresponding to each prediction sub-probability and a target category value corresponding to the target label, where a sum of the reference probability and the corresponding prediction sub-probability is equal to 1, and a sum of the reference category value and the category value is equal to 1; multiply each reference probability by the target category value, to obtain a third target loss value corresponding to each reference probability, and add third target loss values to obtain a fourth target loss value; and add the second target loss value and the fourth target loss value, to obtain the second loss value.

The embodiments of this application provide a computer program product, including computer programs or computer-executable instructions, the computer programs or the computer-executable instructions being stored in a computer-readable storage medium. A processor of an electronic device reads the computer-executable instructions from the computer-readable storage medium, and executes the computer-executable instructions, to cause the electronic device to perform the image classification method provided in the embodiments of this application.

The embodiments of this application provide a computer-readable storage medium, which has computer-executable instructions stored therein. When the computer-executable instructions are executed by a processor, the processor is caused to perform the image classification method provided in the embodiments of this application, such as the image classification method shown in FIG. 4.

The embodiments of this application provide a computer program product, including computer programs or computer-executable instructions, the computer programs or the computer-executable instructions being stored in a computer-readable storage medium. A processor of an electronic device reads the computer-executable instructions from the computer-readable storage medium, and executes the computer-executable instructions, to cause the electronic device to perform the image classification model training method provided in the embodiments of this application.

The embodiments of this application provide a computer-readable storage medium, which has computer-executable instructions stored therein. When the computer-executable instructions are executed by a processor, the processor is caused to perform the image classification model training method provided in the embodiments of this application, such as the image classification model training method shown in FIG. 9.

In some embodiments, the computer-readable storage medium may be a memory such as a read-only memory (ROM), a random access memory (RAM), an erasable programmable read-only memory (EPROM), a flash memory, a magnetic surface memory, an optical disc, or a CD-ROM; or may be various electronic devices including one of or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In the embodiments of this application, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

For example, the computer-executable instructions may be deployed to be executed on one electronic device, or executed on a plurality of electronic devices located at one position, or executed on a plurality of electronic devices that are distributed in a plurality of positions and interconnected by a communication network.

In conclusion, the embodiments of this application have the following beneficial effects:

(1) The to-be-classified images including a plurality of to-be-classified sub-images is converted between different modalities, to obtain modality information of the to-be-classified image that corresponds to each modality; modality fusion is performed on all pieces of modality information, to obtain a multimodal vector corresponding to the to-be-classified image; the to-be-classified image is encoded based on the multimodal vector, to obtain a to-be-classified vector corresponding to the to-be-classified image; category prediction is performed on each to-be-classified sub-image based on the to-be-classified sub-vector corresponding to each to-be-classified sub-image, to obtain a category prediction probability of the to-be-classified sub-image; and the to-be-classified image is classified based on the category prediction probability corresponding to each to-be-classified sub-image, to obtain the category of the to-be-classified image. In this way, modality fusion is performed on modality information obtained by converting the to-be-classified image between different modalities, so that the obtained multimodal vector can accurately reflect modality features of the to-be-classified image from different modalities. In addition, the to-be-classified image is encoded based on the multimodal vector, to obtain the to-be-classified vector, thereby effectively increasing an information amount of the to-be-classified vector. Besides, category prediction is performed on each to-be-classified sub-image based on the to-be-classified vector corresponding to the to-be-classified sub-image. Because the to-be-classified vector on which category prediction is based has a more comprehensive information amount, a category prediction probability obtained through prediction is more accurate. The to-be-classified image is classified based on the accurate category prediction probability, thereby effectively improving information classification accuracy.

(2) The to-be-classified image including a plurality of to-be-classified sub-images are obtained, and the to-be-classified image is converted between different modalities, to obtain modality information of the to-be-classified image that corresponds to each modality, thereby implementing modality conversion on the to-be-classified image. Therefore, multi-dimensional portrayal can be performed on the to-be-classified image from a plurality of different modality dimensions, thereby effectively enhancing an information amount of the to-be-classified image.

(3) The multimodal vector corresponding to the to-be-classified image is obtained by performing modality fusion on all pieces of modality information, significantly enhancing an information amount of the obtained multimodal vector, and providing strong data support for subsequently encoding the to-be-classified image based on the multimodal vector.

(4) The adjusted multimodal sub-vectors are multiplied, to obtain the reference multimodal vector, and the reference multimodal vector is corrected based on the correction parameter, to obtain the to-be-classified vector corresponding to the to-be-classified image, so that the to-be-classified vector corresponding to the to-be-classified image is more accurate.

(5) The highest prediction sub-probability of the prediction probabilities of the to-be-classified sub-sample is determined as the reference prediction probability of the to-be-classified sub-sample, and the candidate category corresponding to the reference prediction probability is determined as the target label of the to-be-classified sub-sample, so that the candidate category corresponding to the highest prediction sub-probability is selected from a plurality of existing candidate categories as the target label of the to-be-classified sub-sample, thereby effectively improving accuracy of the target label.

(6) The highest prediction sub-probability of the prediction probabilities of the to-be-classified sub-sample is determined as the reference prediction probability of the to-be-classified sub-sample, and the candidate category corresponding to the reference prediction probability is determined as the target label of the to-be-classified sub-sample, so that the candidate category corresponding to the highest prediction sub-probability is selected from a plurality of existing candidate categories as the target label of the to-be-classified sub-sample, thereby effectively improving accuracy of the target label.

(7) The initial label of the to-be-classified sub-sample is updated for N rounds, when i is greater than or equal to 2 and the i^{th} update label is the same as an (i−1)^{th} update label, the i^{th} update label is determined as the target label of the to-be-classified sub-sample; or when i is equal to 1 and a first update label is the same as the initial label, the first update label is determined as the target label of the to-be-classified sub-sample. Therefore, accuracy of the target label of the to-be-classified sub-sample is improved, so that the target label can accurately reflect the category of the to-be-classified sub-sample.

(8) The first loss value of the classification model is determined with reference to the prediction probability and the initial label, so as to consider a loss of the classification model from the perspective of the initial label, to obtain the corresponding first loss value. The second loss value of the classification model is determined with reference to the prediction probability and the target label, so as to consider the loss of the classification model from the perspective of the target label, to obtain the corresponding second loss value. The classification model is trained with reference to the first loss value and the second loss value, to obtain the target classification model, so that in the obtained target classification model, the loss of the classification model is considered from both the perspective of the initial label and the perspective of the target label, thereby effectively improving classification performance of the target classification model obtained through training.

(9) The following processing is performed on each to-be-classified sub-sample by traversing i, until the target label of the to-be-classified sub-sample is obtained: determining an i^{th} update vector based on the prediction probability of each to-be-classified sub-sample, where the i^{th} update vector is configured for updating the initial label of the to-be-classified sub-sample for the i^{th} time; updating the initial label of the to-be-classified sub-sample for the i^{th} time with reference to the i^{th} update vector and a sub-sample vector corresponding to the to-be-classified sub-sample, to obtain an i^{th} update label of the to-be-classified sub-sample; and when i is greater than or equal to 2 and the i^{th} update label is the same as an (i−1)^{th} update label, determining the i^{th} update label as the target label of the to-be-classified sub-sample; or when i is equal to 1 and a first update label is the same as the initial label, determining the first update label as the target label of the to-be-classified sub-sample. Therefore, N rounds of label disambiguation are performed on the initial label, so that the accuracy of the obtained target label is higher.

(10) In this embodiment of this application, modeling of the issue of classification of the immune system is reconsidered. A new modeling idea is provided: a simple sequence-level classifier plus robust training. For a special noise label converted from a repertoire-level label, in implementation of this embodiment of this application, a repertoire status may be inferred. This drives many frontier research fields such as treatment of infected and immune illness and design of cancer vaccines.

(11) The target conversion vector and the target correction vector that correspond to the target modality information are obtained, and it is ensured that dimensions of these vectors are the same as a dimension of the modal vector corresponding to the target modality information. Therefore, a series of data processing operations can be performed to optimize and improve representation of the modality information. First, the modal vector corresponding to the target modality information is multiplied by the target conversion vector. This operation can effectively map the original feature to a new feature space, to generate the converted modal vector corresponding to the target modality information. This vector may better reflect an internal structure and relationship of data. Next, the target conversion vector and the target correction vector are added, to obtain an intermediate target modal vector. This intermediate target modal vector is obtained by considering an additional adjustment factor, and may fine-tune or compensate for the original feature. Finally, vector activation is performed on the intermediate target modal vector, which is a type of nonlinear transformation and can further optimize a feature representation form. A finally obtained target modal vector not only includes original modality information, but also integrates converted and corrected information. This processing procedure significantly improves a capability of representing a target task by the modal vector, thereby helping improve model performance and prediction accuracy.

(12) The reference conversion vector and the reference correction vector corresponding to the target modality information are obtained, and it is ensured that dimensions of these vectors are the same as a dimension of the modal vector corresponding to the target modality information, so that multi-source heterogeneous data can be effectively integrated. Specifically, after the transposition operation is performed on the modal vector corresponding to the target modality information, the transposed target modal vector is multiplied by the reference conversion vector to obtain the first reference vector, then the modal vector is multiplied by the first reference vector to obtain the second reference vector, and finally the reference correction vector and the second reference vector are added, to obtain the intermediate multimodal sub-vector that not only retains core features of the original modality information, but also enhances expression accuracy and robustness through correction and conversion, thereby improving fusion quality of the modality information, and providing more precise and comprehensive input for subsequent data analysis and processing. The model has an enhanced adaptability and generalization capability for complex scenarios, and helps improve performance of prediction and classification tasks. Utilization of data resources is optimized, and waste of computing resources is reduced by using an effective vector operation and fusion policy. This provides a more reliable data basis for subsequent advanced applications such as feature extraction and sentiment analysis.

(13) A unified to-be-classified classification eigenvector is generated for features in different modalities, for example, an image and a text. In this process, the reference multimodal eigenvectors are first combined by using an outer product operation, and the combined result is multiplied by the first correction parameter. In this way, not only sizes and directions of the features are adjusted, but also important associations between the features are strengthened. Subsequently, by adding the second correction parameter, the feature representation may be further optimized, so that the feature representation better meets a requirement of a classification task. Processing the result vector by using the ReLU activation function helps introduce non-linearity, so that the classification eigenvector is more diverse and distinguishable in representation. The beneficial effects of this correction and fusion policy are: improving accuracy and robustness of a classification task, so that a model can better extract and use useful information from multimodal data.

(14) Introduction of the weight coefficient can highlight importance of different sub-information in classification, thereby prioritizing key information during comprehensive prediction and reducing interference of noise information. In addition, the target prediction probability obtained after weighted summation better conforms to an actual case because importance and probability distribution of each piece of sub-information are comprehensively considered. Finally, by comparing target prediction probabilities, a candidate category having a highest probability is determined as the category of the to-be-classified image, so that reliability of a classification result can be ensured, and accuracy and robustness of overall classification can be improved. This has significant advantages in multi-attribute decision-making and complex information processing, which helps optimize the performance and efficiency of information classification.

(15) A sample in each modality is processed as the target modality sample, and a sample in another modality is processed as the reference modality sample. This method can ensure that the sample in each modality can be processed, and personalized vector conversion can be performed based on features of the sample in each modality, thereby improving correlation and complementation between modalities. Vector conversion on the vector in the target modality sample not only can highlight features of the target modality sample, and the conversion can enhance fusion with a sample in another modality. Vector fusion is performed on the vector of the target modality sample and the vector of each reference modality sample, to obtain a fused modality sample vector in which information in a plurality of modalities is fused. This operation helps to integrate information in different modalities, thereby improving comprehensiveness and accuracy of feature representation. Vector fusion is performed again on the fused modality sample vector and the target modality sample vector, to obtain the multimodal sample sub-vector, so that original information of the target modality sample and additional information obtained through fusion are further integrated. This multimodal sample sub-vector not only includes diverse feature information, but also provides more accurate and robust data basis for subsequent classification, recognition, or other advanced tasks, thereby helping improve performance of the entire multimodal processing system.

(16) In a multimodal data processing and conversion task, the target conversion vector and the target correction vector corresponding to the target modality sample are obtained, and dimensions of these vectors are the same as the dimension of the modality sample vector. This has the following beneficial effects: First, the converted modal vector is obtained by multiplying the modality sample vector by the target conversion vector, so that an original modality can be effectively mapped to a target modality space. This helps implement effective conversion between modalities and feature preserving. In addition, the target conversion vector and the target correction vector are added, to form the intermediate target modal vector, and further, the mapping result is fine-tuned, helping improve accuracy and vividness of the converted target modality sample. Finally, vector activation is performed on the intermediate target modal vector, to activate a dimension having a prominent feature in the target modality sample vector, thereby generating a sample vector more conforming to feature distribution in the target modality. These series of processing not only improve the efficiency and accuracy of modality conversion, but also enhance a model generalization capability, so that the model can better adapt to a complex conversion relationship between different modalities, and provide strong support for fusion, analysis, and application of multimodal data.

(17) Original information of the target modality sample vector and conversion information provided in reference conversion are effectively combined through vector transposition and multiplication operations. This not only enhances an expression capability of a sample feature, but also helps to disclose correlation between different modalities. The transposed target modal vector is multiplied by the reference conversion vector to obtain the first reference vector, and the first reference vector is multiplied by the modality sample vector to obtain the second reference vector, so that a deeper feature representation can be extracted, respectively corresponding to feature conversion and re-expression, and facilitating wanted signal identification and noise suppression. The reference correction vector and the second reference vector are added, to obtain the fused modality sample vector, and the correction information and the converted feature information are combined, so that the fused modality sample vector retains an original feature, and facilitates understanding and representation of a feature of the target modality sample, thereby improving the accuracy and efficiency of modality fusion.

(18) Consistency in dimensions of the multimodal sub-sample vectors can be ensured, and a standardized basis is provided for a subsequent vector operation. Specifically, the dimension of each sub-sample vector is adjusted to the target dimension, to obtain each corresponding target sub-vector, thereby not only simplifying a processing process of multimodal data, but also improving data processing accuracy. The adjusted multimodal sub-vectors are multiplied, to integrate into a reference multimodal vector. This vector integrates information in different modalities, thereby enhancing a sample feature representation capability. This operation helps to mine internal connections between different modalities, and provides more comprehensive and in-depth information for a subsequent classification task. Correction of the reference multimodal vector based on the correction parameter can further optimize the sample vector, to better adapt to a requirement of a classification task. The corrected sample vector retains original information, and improves classification accuracy and robustness. The process from dimension analysis to vector adjustment and then to correction not only optimizes a multimodal data processing procedure, but also effectively improves performance of a sample vector in a classification task, and provides strong support for a final classification result.

The foregoing descriptions described above are merely the embodiments of this application, and this is not intended to limit the protection scope of this application. Any modification, equivalent replacement, or improvement made within the spirit and scope of this application shall fall within the protection scope of this application.

What is claimed is:

1. An image classification method, performed by an electronic device, comprising:
obtaining a to-be-classified image comprising a plurality of to-be-classified sub-images;
converting the to-be-classified image to a plurality of modalities to obtain modality information of the to-be-classified image corresponding to each of the modalities;
performing modality fusion on all pieces of the modality information to obtain a multimodal vector corresponding to the to-be-classified image;
encoding the to-be-classified image based on the multimodal vector to obtain to-be-classified sub-vectors each corresponding to one of the to-be-classified sub-images; and
classifying the to-be-classified image based on the to-be-classified sub-vectors corresponding to the to-be-classified sub-images to obtain a category of the to-be-classified image among a plurality of candidate categories.

2. The method according to claim 1, wherein the multimodal vector comprises multimodal sub-vectors each corresponding to one of the pieces of modality information, and performing the modality fusion on the all pieces of modality information to obtain the multimodal vector corresponding to the to-be-classified image comprises:
encoding each of the pieces of modality information to obtain a modal vector corresponding to each of the pieces of modality information;
determining the multimodal sub-vectors by performing the following processing on each of the pieces of modality information:
determining each of the pieces of modality information as target modality information, and determining the pieces of modality information other than the target modality information as pieces of reference modality information;
performing vector conversion on a modal vector corresponding to the target modality information to obtain a target modal vector corresponding to the target modality information;
fusing the target modal vector and modal vectors corresponding to each of the pieces of reference modality information to obtain an intermediate multimodal sub-vector corresponding to the target modality information; and
fusing the intermediate multimodal sub-vector and the target modal vector to obtain a multimodal sub-vector corresponding to the target modality information; and
combining the multimodal sub-vectors to obtain the multimodal vector.

3. The method according to claim 2, wherein performing the vector conversion on the modal vector corresponding to the target modality information to obtain the target modal vector corresponding to the target modality information comprises:
obtaining a target conversion vector corresponding to the target modality information and a target correction vector corresponding to the target modality information, wherein a vector dimension of the modal vector corresponding to the target modality information is the same as both vector dimensions of the corresponding target conversion vector and the corresponding target correction vector;
multiplying the modal vector corresponding to the target modality information by the target conversion vector to obtain a converted modal vector corresponding to the target modality information;
adding the converted modal vector and the target correction vector to obtain an intermediate target modal vector corresponding to the target modality information; and
applying an activation function on the intermediate target modal vector to obtain the target modal vector corresponding to the target modality information.

4. The method according to claim 2, wherein fusing the target modal vector and the modal vectors corresponding to each of the pieces of reference modality information to obtain the intermediate multimodal sub-vector corresponding to the target modality information comprises:
obtaining a reference conversion vector corresponding to the target modality information and a reference correction vector corresponding to the target modality information, wherein a vector dimension of the target modal vector corresponding to the target modality information is the same as both vector dimensions of the corresponding reference conversion vector and the corresponding reference correction vector;
performing vector transposition on the target modal vector corresponding to the target modality information to obtain a transposed target modal vector corresponding to the target modality information;
multiplying the transposed target modal vector by the corresponding reference conversion vector, to obtain a first reference vector, and multiplying the first reference vector by the modal vectors each corresponding to one of the pieces of reference modality information to obtain a second reference vector; and
adding the reference correction vector corresponding to the target modality information and the second reference vector to obtain the intermediate multimodal sub-vector corresponding to the target modality information.

5. The method according to claim 1, wherein the multimodal vector comprises multimodal sub-vectors each corresponding to one of the pieces of modality information, and encoding the to-be-classified image based on the multimodal vector to obtain the to-be-classified sub-vectors each corresponding to one of the to-be-classified sub-images comprises:
obtaining vector dimensions of all multimodal sub-vectors;
determining an average value of the vector dimensions of all multimodal sub-vectors as a target dimension;
adjusting vector dimension of each of the multimodal sub-vectors to the target dimension to obtain adjusted multimodal sub-vectors each corresponding to one of the pieces of modality information;
multiplying the adjusted multimodal sub-vectors to obtain a reference multimodal vector,
correcting the reference multimodal vector based on a correction parameter to obtain a to-be-classified vector corresponding to the to-be-classified image, wherein the to-be-classified vector comprises the to-be-classified sub-vectors each corresponding to one of the to-be-classified sub-images; and
obtaining the to-be-classified sub-vectors based on the to-be-classified vector.

6. The method according to claim 5, wherein correcting the reference multimodal vector based on the correction parameter to obtain the to-be-classified vector corresponding to the to-be-classified image comprises:
obtaining a first correction parameter and a second correction parameter;
multiplying the reference multimodal vector by the first correction parameter to obtain an intermediate to-be-classified vector corresponding to the to-be-classified image; and
adding the intermediate to-be-classified vector and the second correction parameter to obtain the to-be-classified vector corresponding to the to-be-classified image.

7. The method according to claim 1, wherein the to-be-classified image is classified by using a target classification model, and before classifying the to-be-classified image based on the to-be-classified sub-vectors corresponding to each of the to-be-classified sub-images to obtain the category of the to-be-classified image from a plurality of candidate categories, the method further comprises:
obtaining a to-be-classified image sample comprising a plurality of to-be-classified sub-samples, and a sample label carried in the to-be-classified image sample;
encoding the to-be-classified image sample to obtain a sample vector corresponding to the to-be-classified image sample, the sample vector comprising sub-sample vectors each corresponding to one of the to-be-classified sub-samples;
determining, for each of the to-be-classified sub-samples, the sample label as an initial label of each of the to-be-classified sub-samples, and invoking a classification model to perform category prediction on each of the to-be-classified sub-samples based on a sub-sample vector corresponding to each of the to-be-classified sub-samples to obtain a prediction probability of each of the to-be-classified sub-samples;
determining a target label of each of the to-be-classified sub-samples based on the prediction probability of each of the to-be-classified sub-samples; and
training the classification model with reference to the predicted probability, the initial label, and the target label to obtain a target classification model.

8. The method according to claim 1, wherein classifying the to-be-classified image based on the to-be-classified sub-vectors each corresponding to one of the to-be-classified sub-images to obtain the category of the to-be-classified image comprises:
performing category prediction on each of the to-be-classified sub-images based on a to-be-classified sub-vector corresponding to each of the to-be-classified sub-images to obtain a category prediction probability corresponding to each of the to-be-classified sub-images, the category prediction probability comprising category probabilities corresponding to each of the candidate categories, each category probability being configured for indicating a probability that each of the to-be-classified sub-images belongs to a corresponding candidate category from the plurality of candidate categories;
obtaining a weight coefficient corresponding to each of the to-be-classified sub-images, the weight coefficient being configured for indicating importance of each of the to-be-classified sub-images in the to-be-classified image;
performing, based on all weight coefficients, weighted summation on category prediction probabilities corresponding to all to-be-classified sub-images to obtain target prediction probabilities corresponding to the to-be-classified image; wherein the target prediction probabilities comprise target probabilities each corresponding to one of the candidate categories, each target probability being configured for indicating a probability that the to-be-classified image belongs to a corresponding candidate category from the plurality of candidate categories; and
determining a candidate category from the plurality of candidate categories having a highest target probability as the category of the to-be-classified image.

9. The method according to claim 1, wherein converting the to-be-classified image to the plurality of modalities to obtain the modality information of the to-be-classified image corresponding to each of the modalities comprises:
when the to-be-classified image is multimodality information:
obtaining all modalities of the to-be-classified image as target modalities; and
extracting modality information of each of the target modalities from the to-be-classified image to obtain the modality information of the to-be-classified image that corresponds to each of the target modalities; or
when the to-be-classified image is single-modality information:
obtaining a plurality of target modalities; and
converting the to-be-classified image to each of the target modalities to obtain the modality information of the to-be-classified image corresponding to each of the target modalities.

10. An image classification model training method, comprising:
obtaining a to-be-classified image sample comprising a plurality of to-be-classified sub-samples, and a sample label carried in the to-be-classified image sample;
encoding the to-be-classified image sample to obtain a sample vector corresponding to the to-be-classified image sample, the sample vector comprising sub-sample vectors each corresponding to one of the to-be-classified sub-samples;
determining, for each of the to-be-classified sub-samples, the sample label as an initial label of each of the to-be-classified sub-samples, and invoking a classification model to perform category prediction on each of the to-be-classified sub-samples based on a sub-sample vector corresponding to each of the to-be-classified sub-samples to obtain a prediction probability of each of the to-be-classified sub-samples, the prediction probability comprising prediction sub-probabilities corresponding to each candidate category from a plurality of candidate categories;
determining a target label for each of the to-be-classified sub-samples based on the prediction probability of each of the to-be-classified sub-samples, the target label comprising a candidate category with a highest sub-probability corresponding to each of the to-be-classified sub-samples; and
training the classification model with reference to the prediction probability, the initial label, and the target label to obtain a target classification model, the target classification model being configured to perform category prediction on to-be-classified sub-images in a to-be-classified image to obtain a prediction probability of each of the to-be-classified sub-images.

11. The method according to claim 10, wherein determining the target label for the each to-be-classified sub-sample based on the prediction probability of the each to-be-classified sub-sample comprises:
performing the following processing on each of the to-be-classified sub-samples by traversing i, until the target label of the to-be-classified sub-sample is obtained:
determining an i^{th} update vector based on the prediction probability of the to-be-classified sub-sample, wherein the i^{th} update vector is configured for updating an initial label of the to-be-classified sub-sample for the i^{th} time;
updating the initial label of the to-be-classified sub-sample for the i^{th} time based on the i^{th} update vector and the sub-sample vector corresponding to the to-be-classified sub-sample to obtain an i^{th} updated label of the to-be-classified sub-sample; and
when i is greater than or equal to 2 and the i^{th} updated label equals to an (i−1)^{th} updated label, determining the i^{th} updated label as the target label of the to-be-classified sub-sample; or
when i is equal to 1 and a first updated label equals to the initial label, determining the first updated label as the target label of the to-be-classified sub-sample;
wherein i is an integer greater or equal to 1.

12. The method according to claim 11, wherein determining the i^{th} update vector based on the prediction probability of each of the to-be-classified sub-sample comprises:
when i is equal to 1, determining a first update vector based on the prediction probability of the to-be-classified sub-sample; or
when i is greater than or equal to 2, performing vector update on the first update vector for an (i−1)^{th} time based on the sub-sample vector corresponding to the to-be-classified sub-sample to obtain the i^{th} update vector.

13. The method according to claim 12, wherein determining the first update vector based on the prediction probability of the each to-be-classified sub-sample comprises:
for each of the candidate categories, selecting, from the plurality of to-be-classified sub-samples based on the prediction probability of the to-be-classified sub-sample, a target sub-sample corresponding to each of the candidate categories based on a determination that a prediction sub-probability of the target sub-sample corresponding to each of the candidate categories being greater than a probability threshold;
determining, for each of the candidate categories, based on a sub-sample vector corresponding to the target sub-sample, a category update vector corresponding to each of the candidate categories; and
performing vector fusion on category update vectors corresponding to the plurality of candidate categories to obtain the first update vector.

14. The method according to claim 13, wherein determining, based on the sub-sample vector corresponding to the target sub-sample, the category update vector corresponding to each of the candidate categories comprises:
when there is one target sub-sample, determining the sub-sample vector corresponding to the target sub-sample as the category update vector corresponding to each of the candidate categories; or
when there is a plurality of target sub-samples, performing vector fusion on sub-sample vectors respectively corresponding to the target sub-samples to obtain the category update vector corresponding to each of the candidate categories.

15. The method according to claim 12, wherein performing the vector update on the first update vector for the (i−1)^{th} time based on the sub-sample vector corresponding to the each to-be-classified sub-sample to obtain the i^{th} update vector comprises:
performing weighted fusion on the (i−1)^{th} update vector and the sub-sample vector corresponding to each of the to-be-classified sub-samples to obtain the i^{th} update vector.

16. The method according to claim 11, wherein updating the initial label of the to-be-classified sub-sample for the i^{th} time based on the i^{th} update vector and the sub-sample vector corresponding to the each to-be-classified sub-sample to obtain the i^{th} updated label of the to-be-classified sub-sample comprises:
obtaining similarity between the i^{th} update vector and the sub-sample vector corresponding to each of the to-be-classified sub-samples; and
when i is equal to 1, performing label update on the initial label of each of the to-be-classified sub-samples based on the similarity to obtain the first updated label of each of the to-be-classified sub-samples; or
when i is greater than 1, updating the (i−1)^{th} updated label of each of the to-be-classified sub-samples based on the similarity to obtain the i^{th} updated label of each of the to-be-classified sub-samples.

17. The method according to claim 10, wherein training the classification model with reference to the prediction probability, the initial label, and the target label to obtain a target classification model comprises:
determining a first loss value of the classification model with reference to the prediction probability and the initial label, and determining a second loss value of the classification model with reference to the prediction probability and the target label; and
training the classification model with reference to the first loss value and the second loss value, to obtain the target classification model.

18. The method according to claim 17, wherein determining the first loss value of the classification model with reference to the prediction probability and the initial label comprises:
multiplying each of the prediction sub-probabilities by a category value corresponding to the initial label to obtain a first reference loss value of each of the prediction sub-probabilities, and summing all first reference loss values to obtain a second reference loss value;
obtaining a reference probability corresponding to each of the prediction sub-probabilities and a reference category value corresponding to the initial label, wherein a sum of the reference probability and the corresponding prediction sub-probability is equal to 1, and a sum of the reference category value and the category value is equal to 1;
multiplying the reference probability corresponding to each of the prediction sub-probabilities by the reference category value to obtain a third reference loss value corresponding to the reference probability, and summing all third reference loss values to obtain a fourth reference loss value; and
adding the second reference loss value and the fourth reference loss value to obtain the first loss value.

19. The method according claim 17, wherein determining the second loss value of the classification model with reference to the prediction probability and the target label comprises:
multiplying each of the prediction sub-probabilities by a category value corresponding to the target label to obtain a first target loss value of the prediction sub-probability, and summing all first target loss values to obtain a second target loss value;
obtaining a reference probability corresponding to each of the prediction sub-probabilities and a target category value corresponding to the target label, wherein a sum of the reference probability and the corresponding prediction sub-probability is equal to 1, and a sum of the target category value and the category value is equal to 1;
multiplying the reference probability corresponding to each of the prediction sub-probabilities by the target category value to obtain a third target loss value corresponding to the reference probability, and summing all third target loss values to obtain a fourth target loss value; and
adding the second target loss value and the fourth target loss value to obtain the second loss value.

20. A computer-readable storage medium, having computer-executable instructions or computer programs stored therein, the computer-executable instructions or the computer programs, when executed by a processor, implementing the method according to claim 1.
